(19) United States
(12) Patent Application Publication
(10) Pub. No.: US 2014/0351760 A1
(43) Pub. Date: Nov. 27, 2014

(54) ORDER-INDEPENDENT TEXT INPUT

(71) Applicant: Google Inc., Mountain View, CA (US)

(72) Inventors: Adam Travis Skory, London (GB); Andrew David Walbran, London (GB)

(73) Assignee: Google Inc., Mountain View, CA (US)

(21) Appl. No.: 13/902,494

(22) Filed: May 24, 2013

(51) Int. Cl. G06F 3/0485

(52) U.S. Cl. CPC G06F 3/0485
USPC 715/830

(57) ABSTRACT

A computing device is described that outputs, for display, a plurality of character input controls. A plurality of characters of a character set is associated with at least one character input control of the plurality of character input controls. The computing device receives an indication of a gesture to select the at least one character input control. The computing device determines, based at least in part on a characteristic of the gesture, at least one character included in the set of characters associated with the at least one character input control. The computing device determines, based at least in part on the at least one character, a candidate character string. In response to determining the candidate character string, the computing device outputs, for display, the candidate character string.

### BACKGROUND

Some computing devices (e.g., mobile phones, tablet computers, etc.) may provide a graphical keyboard as part of a graphical user interface for composing text (e.g., using a presence-sensitive input device and/or display, such as a touchscreen). The graphical keyboard may enable a user of the computing device to enter text (e.g., an e-mail, a text message, or a document, etc.). For instance, a presence-sensitive display of a computing device may output a graphical (or “soft”) keyboard that enables the user to enter data by indicating (e.g., by tapping) keys displayed at the presence-sensitive display. In some examples, a computing device that provides a graphical keyboard may rely on techniques (e.g., character string prediction, auto-completion, auto-correction, etc.) for determining a character string (e.g., a word) from an input. To a certain extent, graphical keyboards and these techniques may speed up text entry at a computing device.

However, graphical keyboards and these techniques may have certain drawbacks. For instance, a computing device may rely on accurate and sequential input of a string-prefix to accurately predict, auto-complete, and/or auto-correct a character string. A user may not know how to correctly spell an intended string-prefix. In addition, the size of a graphical keyboard and the corresponding keys may be restricted to conform to the size of the display that presents the graphical keyboard. A user may have difficulty typing at a graphical keyboard presented at a small display (e.g., on a mobile phone) and the computing device that provides the graphical keyboard may not correctly determine which keys of the graphical keyboard are being selected.

### SUMMARY

In one example, the disclosure is directed to a method that includes outputting, by a computing device and for display, a plurality of character input controls, wherein a plurality of characters of a character set is associated with at least one character input control of the plurality of character input controls. The method further includes receiving, by the computing device, an indication of a gesture to select the at least one character input control. The method further includes determining, by the computing device and based at least in part on a characteristic of the gesture, at least one character included in the set of characters associated with the at least one character input control. The method further includes determining, by the computing device and based at least in part on the at least one character, a candidate character string. In response to determining the candidate character string, the method further includes outputting, by the computing device and for display, the candidate character string.

In another example, the disclosure is directed to a computing device that includes at least one processor, a presence-sensitive input device, a display device, and at least one module operable by the at least one processor to output, for display at the display device, a plurality of character input controls, wherein a plurality of characters of a character set is associated with at least one character input control of the plurality of character input controls. The at least one module is further operable by the at least one processor to receive, an indication of a gesture detected at the presence-sensitive input device to select the at least one character input control. The at least one module is further operable by the at least one processor to determine, based at least in part on a characteristic of the gesture, at least one character included in the set of characters associated with the at least one character input control. The at least one module is further operable by the at least one processor to determine, based at least in part on the at least one character, a candidate character string. In response to determining the candidate character string, the at least one module is further operable by the at least one processor to output, for display at the display device, the candidate character string.

In another example, the disclosure is directed to a computer-readable storage medium encoded with instructions that, when executed, cause at least one processor of a computing device to output, for display, a plurality of character input controls, wherein a plurality of characters of a character set is associated with at least one character input control of the plurality of character input controls. The computer-readable storage medium is further encoded with instructions that, when executed, cause the at least one processor of the computing device to receive, an indication of a gesture to select the at least one character input control. The computer-readable storage medium is further encoded with instructions that, when executed, cause the at least one processor of the computing device to determine, based at least in part on a characteristic of the gesture, at least one character included in the set of characters associated with the at least one character input control. The computer-readable storage medium is further encoded with instructions that, when executed, cause the at least one processor of the computing device to determine, based at least in part on the at least one character, a candidate character string. In response to determining the candidate character string, the computer-readable storage medium is further encoded with instructions that, when executed, cause the at least one processor of the computing device to output, for display, the candidate character string.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device that is configured to determine order-independent text input, in accordance with one or more aspects of the present disclosure.

FIG. 2 is a block diagram illustrating an example computing device, in accordance with one or more aspects of the present disclosure.

FIG. 3 is a block diagram illustrating an example computing device that outputs graphical content for display at a remote device, in accordance with one or more techniques of the present disclosure.

FIGS. 4A-4D are conceptual diagrams illustrating example graphical user interfaces for determining order-independent text input, in accordance with one or more aspects of the present disclosure.

FIG. 5 is a flowchart illustrating an example operation of the computing device, in accordance with one or more aspects of the present disclosure.

### DETAILED DESCRIPTION

In general, this disclosure is directed to techniques for determining user-entered text based on a gesture to select one or more character input controls of a graphical user interface. In some examples, a computing device that outputs a plurality of character input controls at a presence-sensitive display can also receive indications of gestures at the presence-sensitive display. In some examples, a computing device may determine that an indication of a gesture detected at a presence-sensitive input device indicates a selection of one or more character input controls and a selection of one or more associated characters. The computing device may determine a candidate character string (e.g., a probable character string that a user intended to enter with the gesture) from the selection.

In one example, the computing device may present character input controls as a row of rotatable columns of characters. Each character input control may include one or more selectable characters of an associated character set (e.g., an alphabet). The computing device may detect an input to rotate one of the character input controls and, based on the input, the computing device may change the current character associated with the character input control to a different character of the associated character set.

In certain examples, the computing device may determine a candidate character string irrespective of an order in which the user selects the one or more character input controls and associated characters. For instance, rather than requiring the user to provide indications of sequential input to enter a string-prefix or a complete character string (e.g., similar to typing at a keyboard), the computing device may receive one or more indications of input to select character input controls that correspond to characters at any positions of a candidate character string. That is, the user may select the character input control of a last and/or middle character before a character input control of a first character of a candidate character string. The computing device may determine candidate character strings based on user inputs to select, in any order, character input controls of any one or more of the characters of the candidate character string.

In addition, the computing device may determine a candidate character string that the user may be trying to enter without requiring a selection of each and every individual character of the string. For example, the computing device may determine unselected characters of a candidate string based only on selections of character input controls corresponding to some of the characters of the string.

The techniques described may provide an efficient way for a computing device to determine text from user input and provide a way to receive user input for entering a character string (e.g., a word) at smaller sized screens. For instance, rather than requiring the user to enter a prefix of a character string by selecting individual keys corresponding to the first characters of the character string, the user can select just one or more character input controls, in any order, and based on the selection, the computing device can determine one or more candidate character strings. These techniques may speed up text entry by a user since the user can provide fewer inputs to enter text at the computing device.

In addition, since each character of a character set may be selected from each character input control, the quantity of character input controls needed to enter a character string can be fewer than the quantity of keys of a keyboard. For example, the quantity of character input controls may be limited to a quantity of characters in a candidate character string which may be less than the quantity of keys of a keyboard. As a result, character input controls can be presented at a smaller screen than a screen that is sized to receive accurate input at each key of a graphical keyboard.

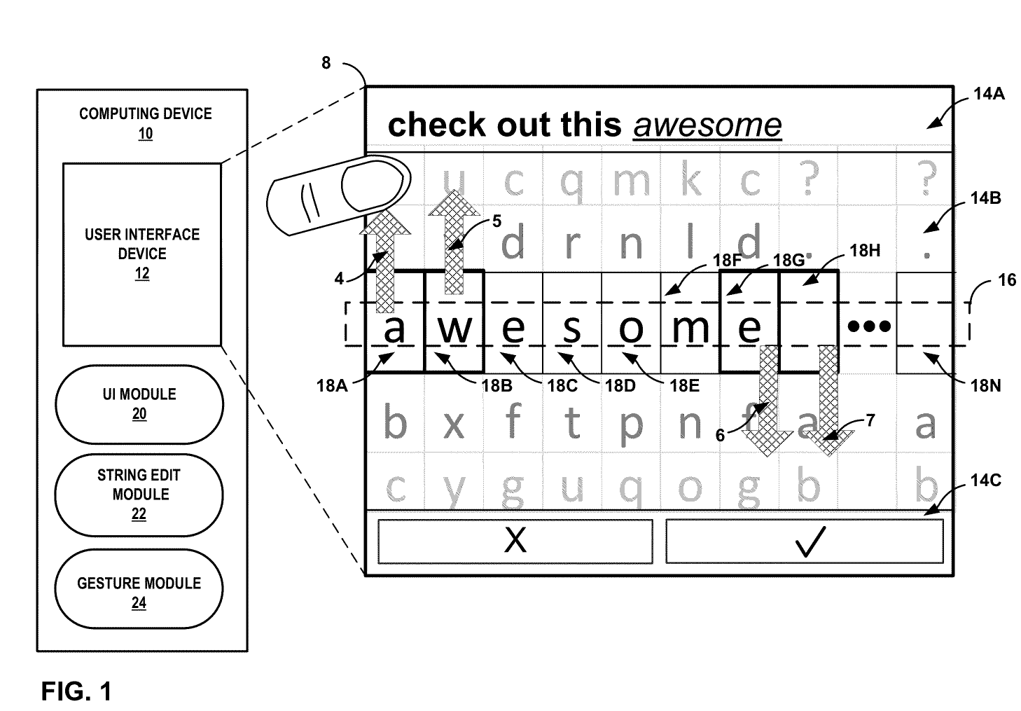

FIG. 1 is a conceptual diagram illustrating an example computing device that is configured to determine order-independent text input, in accordance with one or more aspects of the present disclosure. In the example of FIG. 1, computing device 10 may be a mobile phone. However, in other examples, computing device 10 may be a tablet computer, a personal digital assistant (PDA), a laptop computer, a gaming device, a media player, an e-book reader, a watch, a television platform, or another type of computing device.

As shown in FIG. 1, computing device 10 includes a user interface device (UID) 12. UID 12 of computing device 10 may function as an input device for computing device 10 and as an output device. UID 12 may be implemented using various technologies. For instance, UID 12 may function as a presence-sensitive input device using a presence-sensitive screen, such as a resistive touchscreen, a surface acoustic wave touchscreen, a capacitive touchscreen, a projective capacitance touchscreen, a pressure sensitive screen, an acoustic pulse recognition touchscreen, or another presence-sensitive screen technology. UID 12 may function as an output device, such as a display device, using any one or more of a liquid crystal display (LCD), dot matrix display, light emitting diode (LED) display, organic light-emitting diode (OLED) display, e-ink, or similar monochrome or color display capable of outputting visible information to the user of computing device 10.

UID 12 of computing device 10 may include a presence-sensitive screen that can receive tactile user input from a user of computing device 10 and present output. UID 12 may receive indications of the tactile user input by detecting one or more tap and/or non-tap gestures from a user of computing device 10 (e.g., the user touching or pointing at one or more locations of UID 12 with a finger or a stylus pen) and in response to the input, computing device 10 may cause UID 12 to present output. UID 12 may present the output as a user interface (e.g., user interface 8) which may be related to functionality provided by computing device 10. For example, UID 12 may present various user interfaces of applications (e.g., an electronic message application, an Internet browser application, etc.) executing at computing device 10. A user of computing device 10 may interact with one or more of these applications to perform a function with computing device 10 through the respective user interface of each application.

Computing device 10 may include user interface (“UI”) module 20, string edit module 22, and gesture module 24. Modules 20, 22, and 24 may perform operations using software, hardware, firmware, or a mixture of hardware, software, and/or firmware residing in and executing on computing device 10. Computing device 10 may execute modules 20, 22, and 24, with multiple processors. Computing device 10 may execute modules 20, 22, and 24 as a virtual machine executing on underlying hardware.

Gesture module 24 of computing device 10 may receive from UID 12, one or more indications of user input detected at UID 12. Generally, each time UID 12 receives an indication of user input detected at a location of the presence-sensitive screen, gesture module 24 may receive information about the user input from UID 12. Gesture module 24 may assemble the information received from UID 12 into a time-ordered sequence of touch events. Each touch event in the sequence may include data or components that represents parameters (e.g., when, where, originating direction) characterizing a presence and/or movement of input at the presence-sensitive screen.

Gesture module 24 may determine one or more characteristics of the user input based on the sequence of touch events. For example, gesture module 24 may determine from location and time components of the touch events, a start location of the user input, an end location of the user input, a speed of a portion of the user input, and a direction of a portion of the user input. Gesture module 24 may include, as parameterized data within one or more touch events in the sequence of touch events, information about the one or more determined characteristics of the user input (e.g., a direction, a speed, etc.). Gesture module 24 may transmit, as output to UI module 20, the sequence of touch events including the components or parameterized data associated with each touch event.

UI module 20 may cause UID 12 to display user interface 8. User interface 8 includes graphical elements displayed at various locations of UID 12. FIG. 1 illustrates edit region 14A of user interface 8, input control region 14B of user interface 8, and confirmation region 14C. Edit region 14A may include graphical elements such as images, objects, hyperlinks, characters, symbols, etc. Input control region 14B includes graphical elements displayed as character input controls (“controls”) 18A through 18N (collectively “controls 18”). Confirmation region 14C includes selectable buttons for a user to verify, clear, and/or reject the contents of edit region 14A.

In the example of FIG. 1, edit region 14A includes graphical elements displayed as characters of text (e.g., one or more words or character strings). A user of computing device 10 may enter text in edit region 14A by providing input at portions of UID 12 corresponding to locations where UID 12 displays controls 18 of input control region 14B. For example, a user may gesture at one or more controls 18 by flicking, swiping, dragging, tapping, or otherwise indicating with a finger and/or stylus pen at or near locations of UID 12 where UID 12 presents controls 18. In response to user input such as this, computing device 10 may output one or more candidate character strings in edit region 14A (illustrated as the English word “awesome”). The user may confirm or reject the one or more candidate character strings in edit region 14A by selecting one or more of the buttons in confirmation region 14C. In some examples, user interface does not include confirmation region 14C and the user may confirm or reject the one or more candidate character strings in edit region 14A by providing other input at computing device 10.

Computing device 10 may receive an indication of an input to confirm the candidate character string, and computing device 10 may output the candidate character string for display in response to the input. For instance, computing device 10 may detect a selection of a physical button, detect an indication of an audio input, detect an indication of a visual input, or detect some other input that indicates user confirmation or rejection of the one or more candidate character strings. In some examples, computing device 10 may determine a confirmation or rejection of the one or more candidate character strings based on a swipe gesture detected at UID 12. For instance, computing device 10 may receive an indication of a horizontal gesture that moves from the left edge of UID 12 to the right edge (or vice versa) and based on the indication determine a confirmation or rejection of the one or more candidate character strings. In any event, in response to the confirmation or rejection determination, computing device 10 may cause UID 12 to present the candidate character string for display (e.g., within edit region 14A).

Controls 18 can be used to input a character string for display within edit region 14A. Each one of controls 18 corresponds to an individual character position of the character string.

From left to right, control 18A corresponds to the first character position of the character string and control 18N corresponds to the n^{th} or in some cases, the last character position of the character string. Each one of controls 18 represents a slidable column or virtual wheel of characters of an associated character set with a character set representing every selectable character that can be included in each position of the character string being entered in edit region 14A. The current character of each one of controls 18 represents the character in the corresponding position of the character string being entered in edit region 14A. For example, FIG. 1 shows controls 18A-18N with respective current characters ‘a’, ‘w’, ‘e’, ‘s’, ‘o’, ‘m’, ‘e’, ‘ ’, . . . , ‘ ’. Each of these respective current characters corresponds to a respective character, in a corresponding character position, of the character string “awesome” in edit region 14A.

In other words, controls 18 may be virtual selector wheels. To rotate a virtual selector wheel, a user of a computing device may perform a gesture at a portion of a presence-sensitive screen that corresponds to a location where the virtual selector wheel is displayed. Different positions of the virtual selector wheel are associated with different selectable units of data (e.g., characters). In response to a gesture, the computing device graphically “rotates the wheel” which causes the current (e.g., selected) position of the wheel, and the selectable unit of data, to increment forward and/or decrement backward depending on the speed and the direction of the gesture with which the wheel is rotated. The computing device may determine a selection of the selectable unit of data associated with the current position on the wheel.

The operation of controls 18 is discussed in further detail below; however, each one of controls 18 may represent a wheel of individual characters of a character set positioned at individual locations on the wheel. A character set may include each of the alphanumeric characters of an alphabet (e.g., the letters a through z, numbers 0 through 9), white space characters, punctuation characters, and/or other control characters used in text input, such as the American Standard Code for Information Interchange (ASCII) character set and the Unicode character set. Each one of controls 18 can be incremented or decremented with a gesture at or near a portion of UID 12 that corresponds to a location where one of controls 18 is displayed. The gesture may cause the computing device to increment and/or decrement (e.g., graphically rotate or slide) one or more of controls 18. Computing device 10 may change the one or more current characters that correspond to the one or more (now rotated) controls and, in addition, change the corresponding one or more characters of the character string being entered into edit region 14A.

In some examples, the characters of each one of controls 18 are arrayed (e.g., arranged) in a sequential order. In addition, the characters of each one of controls 18 may be represented as a wrap-around sequence or list of characters. For instance the characters may be arranged in a circular list with the characters representing letters being collocated in a first part of the list and arranged alphabetically, followed by the characters representing numbers being collocated in a second part of the list and arranged numerically, followed by the characters representing whitespace, punctuation marks, and other text based symbols being collocated in a third part of the list and followed by or adjacent to the first part of the list (e.g., the characters in the list representing letters). In other words, in some examples, the set of characters of each one of controls 18 wraps infinitely such that no character set includes a true ‘beginning’ or ‘ending’. A user may perform a gesture to scroll, grab, drag, and/or otherwise fling one of controls 18 to select a particular character in a character set. In some examples, a single gesture may select and manipulate the characters of multiple controls 18 at the same time. In any event, depending on the direction and speed of the gesture, in addition to other factors discussed below such as lexical context, a current or selected character of a particular one of controls 18 can be changed to correspond to one of the next and/or previous adjacent characters in the list.

In addition to controls 18, input control region 14B includes one or more rows of characters above and/or below controls 18. These rows depict the previous and next selectable characters for each one of controls 18. For example, FIG. 1 illustrates control 18C having a current character ‘s’ and the next characters associated with control 18C as being, in order, ‘t’ and ‘u.’ and the previous characters as being ‘r’ and ‘q.’ In some examples, these rows of characters are not displayed. In some examples, the characters in these rows are visually distinct (e.g., through lighter shading, reduced brightness, opacity, etc.) from each one of the current characters corresponding to each of controls 18. The characters presented above and below the current characters of controls 18 represent a visual aid to a user for deciding which way to maneuver (e.g., by sliding the column or virtual wheel) each of controls 18. For example, an upward moving gesture that starts at or near control 18C may advance the current character within control 18C forward in the character set of control 18C to either the ‘t’ or the ‘u.’ A downward moving gesture that starts at or near control 18C may regress the current character backward in the character set of control 18C to either the ‘r’ or the ‘q.’

FIG. 1 illustrates confirmation region 14C of user interface 8 having a two graphical buttons that can be selected to either confirm or reject a character string displayed across the plurality of controls 18. For instance, pressing the confirm button may cause computing device 10 to insert the character string within edit region 14A. Pressing the clear or reject button may cause computing device 10 to clear the character string displayed across the plurality of controls 18 and instead include default characters within each of controls 18. In some examples, confirmation region 14C may include more or fewer buttons. For example, confirmation region 14C may include a keyboard button to replace controls 18 with a QUERTY keyboard. Confirmation region 14C may include a number pad button to replace controls 18 with a number pad. Confirmation region 14C may include a punctuation button to replace controls 18 with one or more selectable punctuation marks. In this way, confirmation region 14C may provide for “toggling” by a user back and forth between a graphical keyboard and controls 18. In some examples, confirmation region 14C is omitted from user interface 8 and other techniques are used to confirm and/or reject a candidate character string within edit region 14A. For instance, computing device 10 may receive an indication of an input to select a physical button or switch of computing device 10 to confirm or reject a candidate character string, computing device 10 may receive an indication of an audible or visual input to confirm or reject a candidate character string, etc.

UI module 20 may act as an intermediary between various components of computing device 10 to make determinations based on input detected by UID 12 and generate output presented by UID 12. For instance, UI module 20 may receive, as an input from string edit module 22, a representation of controls 18 included in input control region 14B. UI module 20 may receive, as an input from gesture module 24, a sequence of touch events generated from information about a user input detected by UID 12. UI module 20 may determine, based on the location components of the touch events in the sequence touch events from gesture module 24, that the touch events approximate a selection of one or more controls (e.g., UI module 20 may determine the location of one or more of the touch events corresponds to an area of UID 12 that presents input control region 14B). UI module 20 may transmit, as output to string edit module 22, the sequence of touch events received from gesture module 24, along with locations where UID 12 presents controls 18. In response, UI module 20 may receive, as data from string edit module 22, a candidate character string and information about the presentation of controls 18. Based on the information from string edit module 22, UI module 20 may update user interface 8 to include the candidate character string within edit region 14A and alter the presentation of controls 18 within input control region 14B. UI module 20 may cause UID 12 to present the updated user interface 8.

String edit module 22 of computing device 10 may output a graphical layout of controls 18 to UI module 20 (for inclusion within input control region 14B of user interface 8). String edit module 22 of computing device 10 may determine which character of a respective character set to include in the presentation a particular one of controls 18 based in part on information received from UI module 20 and gesture module 24 associated with one or more gestures detected within input control region 14B. In addition, string edit module 22 may determine and output one or more candidate character strings to UI module 20 for inclusion in edit region 14A.

For example, string edit module 22 may share a graphical layout with UI module 20 that includes information about how to present controls 18 within input control region 14B of user interface 8 (e.g., what character to present in which particular one of controls 18). As UID 12 presents user interface 8, string edit module 22 may receive information from UI module 20 and gesture module 24 about one or more gestures detected at locations of UID 12 within input control region 14B. As is described below in more detail, based at least in part on the information about these one or more gestures, string edit module 22 may determine a selection of one or more controls 18 and determine a current character included in the set of characters associated with each of the selected one or more controls 18.

In other words, string edit module 22 may compare the locations of the gestures to locations of controls 18. String edit module 22 may determine the one or more controls 18 that have locations nearest to the one or more gestures are the one or more controls 18 being selected by the one or more gestures. In addition, and based at least in part on the information about the one or more gestures, string edit module 22 may determine a current character (e.g., the character being selected) within each of the one or more selected controls 18.

From the selection of controls 18 and the corresponding selected characters, string edit module 22 may determine one or more candidate character strings (e.g., character strings or words in a lexicon) that may represent user-intended text for inclusion in edit region 14A. String edit module 22 may output the most probable candidate character string to UI module 20 with instructions to include the candidate character string in edit region 14A and to alter the presentation of each of controls 18 to include, as current characters, the characters of the candidate character string (e.g., by including each character of the candidate character string in a respective one of controls 18).

The techniques described may provide an efficient way for a computing device to determine text from user input and provide a way to receive user input for entering a character string at smaller sized screens. For instance, rather than requiring the user to enter a prefix of a character string by selecting individual keys corresponding to the first n characters of the character string, the user can select just one or more controls, in any order and/or combination, and based on the selection, the computing device can determine a character string using, as one example, prediction techniques of the disclosure. These techniques may speed up text entry by a user since the user can provide fewer inputs to enter text at the computing device. A computing device that receives fewer inputs may perform fewer operations as a result perform consume less electrical power.

In addition, since each character of a character set may be selected from each control, the quantity of controls needed to enter a character string can be fewer that the quantity of keys of a keyboard. As a result, controls can be presented at a smaller screen than a conventional screen that is sized sufficiently to receive accurate input at each key of a graphical keyboard. By reducing the size of the screen where a computing device receives input, the techniques may provide more use cases for a computing device than other computing devices that rely on more traditional keyboard based input techniques and larger screens. A computing device that relies on these techniques and/or a smaller screen may consume less electrical power than computing devices that rely on other techniques and/or larger screens.

In accordance with techniques of this disclosure, computing device 10 may output, for display, a plurality of character input controls. A plurality of characters of a character set may be associated with at least one character input control of the plurality of controls. For example, UI module 20 may receive from string edit module 22 a graphical layout of controls 18. The layout may include information including which character of a character set (e.g., letters ‘a’ through ‘z’, ASCII, etc.), the current character, to present within a respective one of controls 18. UI module 20 may update user interface 8 to include controls 18 and the respective current characters according to the graphical layout from string edit module 22. UI module 20 may cause UID 12 to present user interface 8.

In some examples, the graphical layout that string edit module 22 transmits to UI module 20 may include the same, default, current character for each one of controls 18. The example shown in FIG. 1 assumes that string edit module 22 defaults the current character of each of controls 18 to a space ‘ ’ character. In other examples, string edit module 22 may default the current characters of controls 18 to characters of a candidate character string, such as a word or character string determined by a language model. For instance, using an n-gram language model, string edit module 22 may determine a quantity of n previous character strings entered into edit region 14A and, based on probabilities determined by the n-gram language model, string edit module 22 may set the current characters of controls 18 to the characters that make up a most probable character string to follow the n previous character strings. The most probable character string may represent a character string that the n-gram language model determines has a likelihood of following n previous character strings entered in edit region 14A.

In some examples, the language model used by string edit module 22 to determine the candidate character string may utilize “intelligent flinging” based on character string prediction and/or other techniques. For instance, string edit module 22 may set the current characters of controls 18 to the characters that make up, not necessarily the most probable character string to follow the n previous character strings, but instead, the characters of a less probable character string that also have a higher amount of average information gain. In other words, string edit module 22 may place the characters of a candidate character string at controls 18 in order to place controls 18 in better “starting positions” which minimize the effort needed for a user to select different current characters with controls 18. That is, controls 18 that are placed in starting positions based on average information gain may minimize the effort needed to change the current characters of controls 18 to the correct positions intended by a user with subsequent inputs from the user. For example, if the previous two words entered into edit region 14A are “where are” the most probable candidate character string based on a bi-gram language model to follow these words may be the character string “you.” However by presenting the characters of the character string “you” at character input controls 18, more effort may need to be exerted by a user to change the current characters of controls 18 to a different character string. Instead, string edit module 22 may present the characters of a less probable candidate character string, such as “my” or “they”, since the characters of these candidate character strings, if used as current characters of controls 18, would place controls 18 in more probable “starting positions,” based on average information gain, for a user to select different current characters of controls 18.

In other words, the language model used by string edit module 22 to determine the current characters of controls 18, prior to any input from a user, may not score words based only on their n-gram likelihood, but instead may use a combination of likelihood and average information gain to score character sets. For example, when the system suggests the next word (e.g., the candidate character string presented at controls 18), that word may not actually be the most likely word given the n-gram model, but instead a less-likely word that puts controls 18 in better positions to reduce the likely effort to change the current characters into other likely words the user might want entered into edit region 14A.

Computing device 10 may receive an indication of a gesture to select at least one character input control. For example, based at least in part on a characteristic of the gesture, string edit module 22 may update and change the current character of the selected character input control to a new current character (e.g., a current character different from the default character). For instance, a user of computing device 10 may wish to enter a character string within edit region 14A of user interface 8. The user may provide gesture 4 at a portion of UID 12 that corresponds to a location where UID 12 presents one or more of controls 18. FIG. 1 shows the path of gesture 4 as indicated by an arrow to illustrate a user swiping a finger and/or stylus pen at UID 12. Gesture module 24 may receive information about gesture 4 from UID as UID 12 detects gesture 4 being entered. Gesture module 24 may assemble the information from UID 12 into a sequence of touch events corresponding to gesture 4. Gesture module 24 may, in addition, determine one or more characteristics of gesture 4, such as the speed, direction, velocity, acceleration, distance, start and end location, etc. Gesture module 24 may transmit the sequence of touch events and characteristics of gesture 4 to UI module 20. UI module 20 may determine that the touch events represent input at input control region 14B and in response, UI module 20 may pass data corresponding to the touch events and characteristics of gesture 4 to string edit module 22.

Computing device 10 may determine, based at least in part on a characteristic of gesture 4, at least one character included in the set of characters associated with the at least one control 18. For example, string edit module 22 may receive data corresponding to the touch events and characteristics of gesture 4 from UI module 20. In addition, string edit module 22 may receive locations of each of controls 18 (e.g., Cartesian coordinates that correspond to locations of UID 12 where UID 12 presents each of controls 18). String edit module 22 may compare the locations of controls 18 to the locations within the touch events and determine that the one or more controls 18 that have locations nearest to the touch event locations are being selected by gesture 4. String edit module 22 may determine that control 18A is nearest to gesture 4 and that gesture 4 represents a selection of control 18A.

String edit module 22 may determine, based at least in part on the one or more characteristics of gesture 4, a current character included in the set of characters of selected control 18A. In some examples, string edit module 22 may determine the current character based at least in part on contextual information of other controls 18, previous character strings in edit region 14A, and/or probabilities of each of the characters in the set of characters of the selected control 18.

For example, a user can select one of controls 18 and change the current character of the selected control by gesturing at or near portions of UID 12 that correspond to locations of UID 12 where controls 18 are displayed. String edit module 22 may slide or spin a selected control with a gesture having various characteristics of speed, direction, distance, location, etc. String edit module 22 may change the current character of a selected control to the next or previous character within the associated character set based on the characteristics of the gesture. String edit module 22 may compare the speed of a gesture to a speed threshold. If the speed satisfies the speed threshold, string edit module 22 may determine the gesture is a “fling”, otherwise, string edit module may determine the gesture is a “scroll.” String edit module 22 may change the current character of a selected control 18 differently for a fling than for a scroll.

For instance, in cases when string edit module 22 determines a gesture represents a scroll, string edit module 22 may advance the current character of a selected control 18 by a quantity of characters that is approximately proportionate to the distance of the gesture (e.g., there may be a 1-to-1 ratio of the distance the gesture travels and the number of characters the current character advances either forward or backward in the set of characters). In the event string edit module 22 determines a gesture represents a fling, string edit module 22 may advance the current character of a selected control 18 by a quantity of characters that is approximately proportionate to the speed of the gesture (e.g., by multiplying the speed of the touch gesture by a deceleration coefficient, with the number of characters being greater for a faster speed gesture and lesser for a slower speed gesture). String edit module 22 may advance the current character either forward or backward within the set of characters depending on the direction of the gesture. For instance, string edit module 22 may advance the current character forward in the set, for an upward moving gesture, and advances the current character backward, for a downward moving gesture.

In some examples, in addition to using the characteristics of a gesture, string edit module 22 may determine the current character of a selected one of controls 18 based on contextual information of other current characters of other controls 18, previous character strings entered into edit region 14A, or probabilities of the characters in the set of characters associated with the selected control 18. In other words, string edit module 22 may utilize “intelligent flinging” based on character prediction and/or language modeling techniques to determine the current character of a selected one of controls 18 and may utilize a character-level and/or string-level (e.g., word-level) n-gram model to determine a current character with a probability that satisfies a likelihood threshold of being the current character selected by gesture 4. For example, if the current characters of controls 18A-18E are, respectively, the characters ‘c’ ‘a’ ‘l’ ‘i’ ‘f’, string edit module 22 may determine the current character of control 18F is the character ‘o’, since string edit module 22 may determine the letter ‘o’ has a probability that satisfies a likelihood threshold of following the characters ‘calif.’

To make flinging and/or scrolling to a different current character easier and more accurate for the user, string edit module 22 may utilize character string prediction techniques to make certain characters “stickier” and to cause string edit module 22 to more often determine the current character is one of the “stickier” characters in response to a fling gesture. For instance, in some examples, string edit module 22 may determine a probability that indicates a degree of likelihood that each character in the set is the selected current character. String edit module 22 may determine the probability of each character by combining (e.g., normalizing) the probabilities of all character strings that could be created with that character, given the current characters of the other selected controls 18, in combination with a prior probability distribution. In some examples, flinging one of controls 18 may cause string edit module 22 to determine the current character corresponds to (e.g., “landed on”) a current character in the set that is more probable of being included in a character string or word in a lexicon than the other characters in the set.

In any event, prior to receiving the indication of gesture 4 to select control 18A, string edit module 22 may determine that the current character of control 18A is the default space character. String edit module 22 may determine, based on the speed and direction of gesture 4, that gesture 4 is a slow, upward moving scroll. In addition, based on contextual information (e.g., previous entered character strings, probabilities of candidate character strings, etc.) string edit module 22 may determine that the letter ‘a’ is a probable character that the user is trying to enter with gesture 4.

As such, string edit module 22 may advance the current character forward from the space character to the next character in the character set (e.g., to the letter ‘a’). String edit module 22 may send information to UI module 20 for altering the presentation of control 18A to include and present the current character ‘a’ within control 18A. UI module 20 may receive the information and cause UID 12 to present the letter ‘a’ within control 18A. String edit module 22 may cause UI module 20 to alter the presentation of selected controls 18 with visual cues, such as a bolder font and/or a black border, to indicate which controls 18 have been selected.

In response to presenting the letter ‘a’ within control 18A, the user may provide additional gestures at UID 12. FIG. 1 illustrates, in no particular order, a path of gesture 5, gesture, 6, and gesture 7. Gestures 4 through 7 may in some examples may be one continuous gesture and in other examples may be more than four or fewer than four individual gestures. In any event, computing device 10 may determine a new current character in the set of characters associated with each one of selected controls 18B, 18G, and 18H.

For example, gesture module 24 may receive information about gestures 4 through 7 from UID 12 and determine characteristics and a sequence of touch events about each of gestures 4. UI module 20 may receive the sequences of touch events and gesture characteristics from gesture module 24 and transmit the sequences and characteristics to string edit module 22. String edit module 22 may determine gesture 5 represents a upward moving fling and based on the characteristics of gesture 5 as well as contextual information about the current characters of other controls 18, as well as language model probabilities, string edit module 22 may advance the current character of control 18B forward from the space character to the ‘w’ character. Likewise, string edit module 22 may determine gesture 6 represents an upward moving gesture and advance the current character of control 18G from the space character to the ‘e’ character and may determine gesture 7 represents a tap gesture (e.g., with little or no directional characteristic and little or no speed characteristic) and not advance the current character of input control 18H. String edit module 22 may utilize contextual information of controls 18 and previous character strings entered into edit region 14A to further refine and determine the current characters of input controls 18B, 18G, and 18H.

In addition to changing and/or not changing the current characters of each selected one of controls 18, string edit module 22 may cause UI module 20 and UID 12 to enhance the presentation of selected controls 18 with a visual cue (e.g., graphical border, color change, font change, etc.) to indicate to a user that computing device 10 registered a selection of that control 18. In some examples, string edit module 22 may receive an indication of a tap at one of previously selected controls 18, and change the visual cue of the tapped control 18 to correspond to the presentation of an unselected control (e.g., remove the visual cue). Subsequent taps may cause the presentation of the tapped controls 18 to toggle from indicating selections back to indicating non-selections.

String edit module 22 may output information to UI module 20 to modify the presentation of controls 18 at UID 12 to include the current characters of selected controls 18. String edit module 22 may further include information for UI module 20 to update the presentation of user interface 8 to include a visual indication that certain controls 18 have been selected (e.g., by including a thick-bordered rectangle around each selected controls 18, darker and/or bolded font within the selected controls 18, etc.).

Computing device 10 may determine, based at least in part on the at least one character, a candidate character string. In other words, string edit module 22 may determine a candidate character string for inclusion in edit region 14A based on the current characters of selected controls 18. For example, string edit module 22 may concatenate each of the current characters of each of the controls 18A through 18N (whether selected or not) to determine a current character string that incorporates all the current characters of each of the selected controls 18. The first character of the current character string may be the current character of control 18A, the last character of the current character string may be the current character of control 18N, and the middle characters of the current character string may include the current characters of each of controls subsequent to control 18A and prior to control 18N. Based on gestures 4 through 7, string edit module 22 may determine the current character string is, for example, a string of characters including ‘a’+‘w’+‘ ’+‘ ’+‘ ’+‘ ’+‘e’+‘ ’+ . . . +‘ ’.

In some examples, string edit module 22 may determine that the first (e.g., from left to right in the row of character controls) occurrence of a current character, corresponding to a selected one of controls 18, that is also an end-of-string character (e.g., a whitespace, a punctuation, etc.) represents the last character n of a current character string. As such, string edit module 22 may bound the length of possible candidate character strings to be n characters in length. If no current characters corresponding to selected controls 18 are end-of-string identifiers, string edit module 22 may determine one or more candidate character strings of any length. In other words, string edit module 22 may determine that because control 18H is a selected one of controls 18 and also includes a current character represented by a space” (e.g., an end-of-string identifier), that the current character string is seven characters long and the current character string is actually a string of characters including ‘a’+‘w’+‘ ’+‘ ’+‘ ’+‘ ’+‘e’. String edit module 22 may limit the determination of candidate character strings to character strings that have a length of seven characters with the first two characters being ‘a’ and ‘w’ and the last character (e.g., seventh character) being the letter ‘e’.

String edit module 22 may utilize similarity coefficients to determine the candidate character string. In other words, string edit module 22 may scan a lexicon (e.g., a dictionary of character strings) for a character string that has a highest similarity coefficient and more closely resembles the current character string than the other words in the lexicon. For instance, a lexicon of computing device 10 may include a list of character strings within a written language vocabulary. String edit module 22 may perform a lookup in the lexicon, of the current character string, to identify one or more candidate character strings that include parts or all of the characters of the current character string. Each candidate character string may include a probability (e.g., a Jaccard similarity coefficient) that indicates a degree of likelihood that the current character string actually represents a selection of controls 18 to enter the candidate character string in edit region 14A. In other words, the one or more candidate character strings may represent alternative spellings or arrangements of the characters in the current character string based on a comparison with character strings within the lexicon.

String edit module 22 may utilize one or more language models (e.g., n-gram) to determine a candidate character string based on the current character string. In other words, string edit module 22 may scan a lexicon (e.g., a dictionary of words or character strings) for a candidate character string that has a highest language model probability (otherwise referred herein as “LMP”) amongst the other character strings in the lexicon.

In general, a LMP represents a probability that a character string follows a sequence of character strings prior character strings (e.g., a sentence). In some examples, a LMP may represent the frequency with which that character string alone occurs in a language, (e.g., a unigram). For instance, to determine a LMP of a character string (e.g., a word), string edit module 22 may use one or more n-gram language models. An n-gram language model may provide a probability distribution for an item xᵢ (character or string) in a contiguous sequence of n items based on the previous n−1 items in the sequence (e.g., P(xᵢ|xᵢ₋₍ₙ₋₁₎, . . . , xᵢ₋₁)). For instance, a quad-gram language model (an n-gram model where n=4), may provide a probability that a candidate character string follows the three character strings “check this out” in a sequence (e.g., a sentence).

In addition, some language models include back-off techniques such that, in the event the LMP of the candidate character string is below a minimum probability threshold and/or near zero, the language model may decrements the quantity of ‘n’ and transition to an (n−1)-gram language model until the LMP of the candidate character string is either sufficiently high (e.g., satisfies the minimum probability threshold) or the value of n is 1. For instance, in the event that the quad-gram language model returns a zero LMP for the candidate character string, string edit module 22 may subsequently use a tri-gram language model to determine the LMP that the candidate character string follows the character strings “out this.” If the LMP for the candidate character string does not satisfy a threshold (e.g., is less than the threshold), string edit module 22 may subsequently use a bi-gram language model and if the LMP does not satisfy a threshold based on the bi-gram language model, string edit module 22 may determine that the LMP of no character strings in the lexicon satisfy a threshold and that, rather than a different character string in the lexicon being the candidate character string, instead the current character string is the candidate character string.

String edit module 22 may determine one or more character strings previously determined by computing device 10 prior to receiving the indication of gesture 4 and determine, based on the one or more character strings and the at least one character, a language model probability of the candidate character string. The language model probability may indicate a likelihood that the candidate character string is positioned subsequent to the one or more character strings previously received, in a sequence of character strings that includes the one or more character strings and the candidate character string. String edit module 22 may determine the candidate character string based at least in part on the language model probability. For example, string edit module 22 may perform a lookup in a lexicon, of the current character string, to identify one or more candidate character strings that begin with the first and second characters of the current character string (e.g., ‘a’+‘w’), end with the last character of the current character string (e.g., ‘e’) and are the length of the current character string (e.g., seven characters long). String edit module 22 may determine a LMP for each of these candidate character strings that indicates a likelihood that each of the respective candidate character strings follows a sequence of character strings “check out this”. In addition, string edit module 22 may compare the LMP of each of the candidate character strings to a minimum LMP threshold and in the event none of the candidate character strings have a LMP that satisfies the threshold, string edit module 22 may utilize back-off techniques to determine a candidate character string that does have a LMP that satisfies the threshold. String edit module 22 may determine the candidate character string with the highest LMP out of all the candidate character strings represents the candidate character string that the user is trying to enter. In the example of FIG. 1, string edit module 22 may determine the candidate character string is awesome.

In response to or in addition to determining the candidate character string, computing device 10 may output, for display, the candidate character string. For instance, in response to determining the candidate character string is awesome, string edit module 22 may assign the current characters of unselected controls 18 with a respective one of the characters of the candidate character string. Or in other words, string edit module 22 may change the current character of each control 18 not selected by a gesture to be one of the characters of the candidate character string. String edit module 22 may change the current character of unselected controls 18 to be the character in the corresponding position of the candidate character string (e.g., the position of the candidate character string that corresponds to the particular one of controls 18). In this way, the individual characters included in the candidate character string are presented across respective controls 18.

For example, controls 18C, 18D, 18E, and 18F may correspond to the third, fourth, fifth, and sixth character positions of the candidate character string. String edit module 22 may determine no selection of controls 18C through 18F based on gestures 4 through 7. String edit module 22 may assign a character from a corresponding position of the candidate character string as the current character for each unselected control 18. String edit module 22 may determine the current character of control 18C is the third character of the candidate character string (e.g., the letter ‘e’). String edit module 22 may determine the current character of control 18D is the fourth character of the candidate character string (e.g., the letter ‘s’). String edit module 22 may determine the current character of control 18E is the fifth character of the candidate character string (e.g., the letter ‘o’). String edit module 22 may determine the current character of control 18F is the sixth character of the candidate character string (e.g., the letter ‘m’).

String edit module 22 may send information to UI module 20 for altering the presentation of controls 18C through 18F to include and present the current characters ‘e’, ‘s’, ‘o’, and ‘m’ within controls 18C through 18F. UI module 20 may receive the information and cause UID 12 to present the letters ‘e’, ‘s’, ‘o’, and ‘m’ within controls 18C through 18F.

In some examples, string edit module 22 can determine current characters and candidate character strings independent of the order that controls 18 are selected. For example, to enter the character string “awesome”, the user may first provide gesture 7 to set control 18H to a space. The user may next provide gesture 6 to select the letter ‘e’ for control 18G, gesture 5 to select the letter ‘w’ for control 18B, and lastly gesture 4 to select the letter ‘a’ for control 18A. String edit module 22 may determine the candidate character string “awesome” even though the last letter ‘e’ was selected prior to the selection of the first letter ‘a’. In this way, unlike traditional keyboards that require a user to type the characters of a character string in order (e.g., from left-to-right according to the English alphabet), string edit module 22 can determine a candidate character string based on a selection of any of controls 18, including a selection of controls 18 that have characters that make up a suffix of a character string.

In some examples, computing device 10 may receive an indication to confirm that the current character string (e.g., the character string represented by the current characters of each of the controls 18) is the character string the user wishes to enter into edit region 14A. For instance, the user may provide a tap at a location of an accept button within confirmation region 14C to verify the accuracy of the current character string. String edit module 22 may receive information from gesture module 24 and UI module 20 about the button press and cause UI module 20 to cause UID 12 to update the presentation of user interface 8 to include the current character string (e.g., awesome) within edit region 14A.

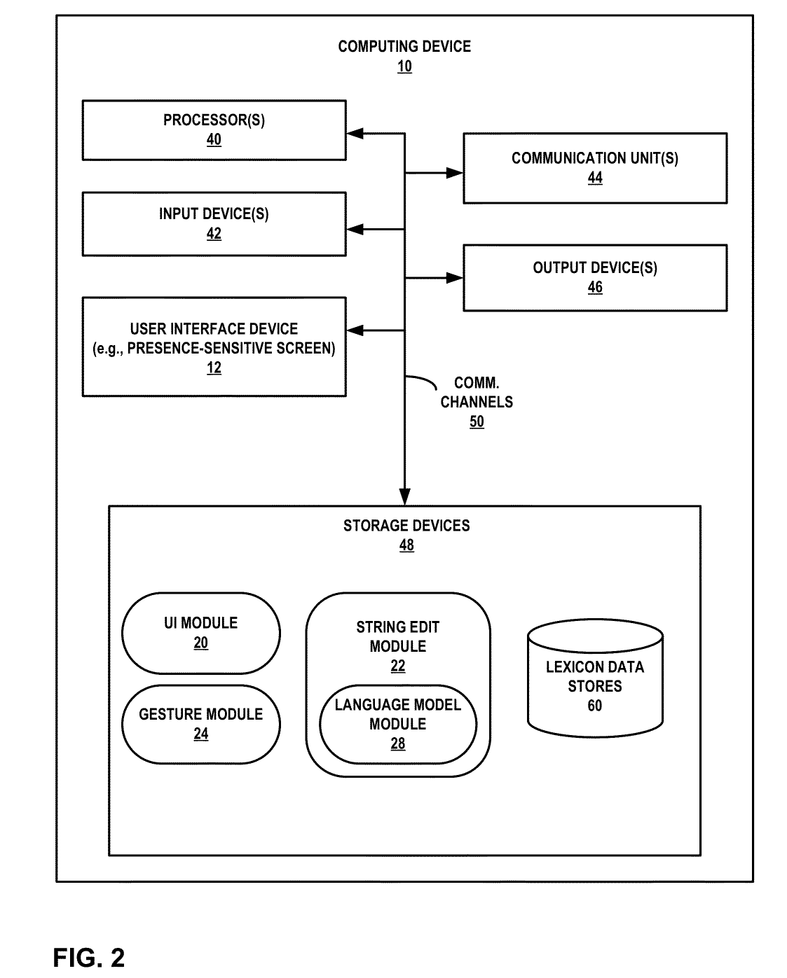

FIG. 2 is a block diagram illustrating an example computing device, in accordance with one or more aspects of the present disclosure. Computing device 10 of FIG. 2 is described below within the context of FIG. 1. FIG. 2 illustrates only one particular example of computing device 10, and many other examples of computing device 10 may be used in other instances and may include a subset of the components included in example computing device 10 or may include additional components not shown in FIG. 2.

As shown in the example of FIG. 2, computing device 10 includes user interface device 12 (“UID 12”), one or more processors 40, one or more input devices 42, one or more communication units 44, one or more output devices 46, and one or more storage devices 48. Storage devices 48 of computing device 10 also include UI module 20, string edit module 22, gesture module 24 and lexicon data stores 60. String edit module 22 includes language model module 26 (“LM module 26”). Communication channels 50 may interconnect each of the components 12, 13, 20, 22, 24, 26, 40, 42, 44, 46, 60, and 62 for inter-component communications (physically, communicatively, and/or operatively). In some examples, communication channels 50 may include a system bus, a network connection, an inter-process communication data structure, or any other method for communicating data.

One or more input devices 42 of computing device 10 may receive input. Examples of input are tactile, audio, and video input. Input devices 42 of computing device 10, in one example, includes a presence-sensitive screen, touch-sensitive screen, mouse, keyboard, voice responsive system, video camera, microphone or any other type of device for detecting input from a human or machine.

One or more output devices 46 of computing device 10 may generate output. Examples of output are tactile, audio, and video output. Output devices 46 of computing device 10, in one example, includes a presence-sensitive screen, sound card, video graphics adapter card, speaker, cathode ray tube (CRT) monitor, liquid crystal display (LCD), or any other type of device for generating output to a human or machine.

One or more communication units 44 of computing device 10 may communicate with external devices via one or more networks by transmitting and/or receiving network signals on the one or more networks. For example, computing device 10 may use communication unit 44 to transmit and/or receive radio signals on a radio network such as a cellular radio network. Likewise, communication units 44 may transmit and/or receive satellite signals on a satellite network such as a GPS network. Examples of communication unit 44 include a network interface card (e.g. such as an Ethernet card), an optical transceiver, a radio frequency transceiver, a GPS receiver, or any other type of device that can send and/or receive information. Other examples of communication units 44 may include Bluetooth®, GPS, 3G, 4G, and Wi-Fi® radios found in mobile devices as well as Universal Serial Bus (USB) controllers.

In some examples, UID 12 of computing device 10 may include functionality of input devices 42 and/or output devices 46. In the example of FIG. 2, UID 12 may be or may include a presence-sensitive screen. In some examples, a presence sensitive screen may detect an object at and/or near the presence-sensitive screen. As one example range, a presence-sensitive screen may detect an object, such as a finger or stylus that is within 2 inches or less of the presence-sensitive screen. The presence-sensitive screen may determine a location (e.g., an (x,y) coordinate) of the presence-sensitive screen at which the object was detected. In another example range, a presence-sensitive screen may detect an object 6 inches or less from the presence-sensitive screen and other ranges are also possible. The presence-sensitive screen may determine the location of the screen selected by a user's finger using capacitive, inductive, and/or optical recognition techniques. In some examples, presence sensitive screen provides output to a user using tactile, audio, or video stimuli as described with respect to output device 46. In the example of FIG. 2, UID 12 presents a user interface (such as user interface 8 of FIG. 1) at UID 12.

While illustrated as an internal component of computing device 10, UID 12 also represents and external component that shares a data path with computing device 10 for transmitting and/or receiving input and output. For instance, in one example, UID 12 represents a built-in component of computing device 10 located within and physically connected to the external packaging of computing device 10 (e.g., a screen on a mobile phone or a watch). In another example, UID 12 represents an external component of computing device 10 located outside and physically separated from the packaging of computing device 10 (e.g., a monitor, a projector, etc. that shares a wired and/or wireless data path with a tablet computer).

One or more storage devices 48 within computing device 10 may store information for processing during operation of computing device 10 (e.g., lexicon data stores 60 of computing device 10 may store data related to one or more written languages, such as character strings and common pairings of character strings, accessed by LM module 26 during execution at computing device 10). In some examples, storage device 48 is a temporary memory, meaning that a primary purpose of storage device 48 is not long-term storage. Storage devices 48 on computing device 10 may configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 48, in some examples, also include one or more computer-readable storage media. Storage devices 48 may be configured to store larger amounts of information than volatile memory. Storage devices 48 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 48 may store program instructions and/or data associated with UI module 20, string edit module 22, gesture module 24, LM module 26, and lexicon data stores 60.

One or more processors 40 may implement functionality and/or execute instructions within computing device 10. For example, processors 40 on computing device 10 may receive and execute instructions stored by storage devices 48 that execute the functionality of UI module 20, string edit module 22, gesture module 24, and LM module 26. These instructions executed by processors 40 may cause computing device 10 to store information, within storage devices 48 during program execution. Processors 40 may execute instructions of modules 20-26 to cause UID 12 to display user interface 8 with edit region 14A, input control region 14B, and confirmation region 14C at UID 12. That is, modules 20-26 may be operable by processors 40 to perform various actions, including receiving an indication of a gesture at locations of UID 12 and causing UID 12 to present user interface 8 at UID 12.

In accordance with aspects of this disclosure computing device 10 of FIG. 2 may output, for display, a plurality of controls. A plurality of characters of a character set is associated with at least one control of the plurality of controls. For example, string edit module 22 may transmit a graphical layout of controls 18 to UI module 20 over communication channels 50. UI module 20 may receive the graphical layout and transmit information (e.g., a command) to UID 12 over communication channels 50 to cause UID 12 to include the graphical layout within input control region 14B of user interface 8. UID 12 may present user interface 8 including controls 18 (e.g., at a presence-sensitive screen).

Computing device 10 may receive an indication of a gesture to select the at least one control. For example, a user of computing device 10 may provide an input (e.g., gesture 4), at a portion of UID 12 that corresponds to a location where UID 12 presents control 18A. As UID 12 receives an indication of gesture 4, UID 12 may transmit information about gesture 4 over communication channels 50 to gesture module 24.

Gesture module 24 may receive the information about gesture 4 and determine a sequence of touch events and one or more characteristics of gesture 4 (e.g., speed, direction, start and end location, etc.). Gesture module 24 may transmit the sequence of touch events and gesture characteristics to UI module 20 to determine a function being performed by the user based on gesture 4. UI module 20 may receive the sequence of touch events and characteristics over communication channels 50 and determine the locations of the touch events correspond to locations of UID 12 where UID 12 presents input control region 14B of user interface 8. UI module 20 may determine gesture 4 represents an interaction by a user with input control region 14B and transmit the sequence of touch events and characteristics over communication channels 50 to string edit module 22.

Computing device 10 may determine, based at least in part on a characteristic of the gesture, at least one character included in the set of characters associated with the at least one control. For example, string edit module 22 may compare the location components of the sequence of touch events to the locations of controls 18 and determine that control 18A is the selected one of controls 18 since control 18A is nearest to the locations of gesture 4. In response to gesture 4, string edit module 22 may command UI module 20 and UID 12 to cause the visual indication of the current character of control 18A at UID 12 to visually appear to move up or down within the set of characters. String edit module 22 may determine gesture 4 has a speed that does not exceed a speed threshold and therefore represents a “scroll” of control 18A. String edit module 22 may determine the current character moves up or down within the set of characters by a quantity of characters that is approximately proportional to the distance of gesture 4. Conversely, string edit module 22 may determine gesture 4 has a speed that does exceed a speed threshold and therefore represents a “fling” of control 18A. String edit module 22 may determine the current character of control 18A moves up or down within the set of characters by a quantity of characters that is approximately proportional to the speed of gesture 4 and in some examples, modified based on a deceleration coefficient.

In some examples, in addition to the characteristics of a gesture, string edit module 22 may utilize “intelligent flinging” or “predictive flinging” based on character prediction and/or language modeling techniques to determine how far to advance or regress (e.g., move up or down) the current character of a selected control 18 within an associated character set. In other words, string edit module 22 may not determine the new current character of control 18A based solely on characteristics of gesture 4 and instead, string edit module 22 may determine the new current character based on contextual information derived from previously entered character strings, probabilities associated with the characters of the set of characters of a selected control 18, and/or the current characters of controls 18B-18N.

For example, string edit module 22 may utilize language modeling and character string prediction techniques to determine the current character of a selected one of controls 18 (e.g., control 18A). The combination of language modeling and character string prediction techniques may make the selection of certain characters within a selected one of controls 18 easier for a user by causing certain characters to appear to be “stickier” than other characters in the set of characters associated with the selected one of controls 18. In other words, when a user “flings” or “scrolls” one of controls 18, the new current character may more likely correspond to a “sticky” character that has a certain degree of likelihood of being the intended character based on probabilities, than the other characters of the set of characters that do not have the certain degree of likelihood.

In performing intelligent flinging techniques, computing device 10 may determine one or more selected characters that each respectively correspond to a different one of controls 18, and determine, based on the one or more selected characters, a plurality of candidate character strings that each includes the one or more selected characters. Each of the candidate character strings may be associated with a respective probability that indicates a likelihood that the one or more selected characters indicate a selection of the candidate character string. Computing device 10 may determine, based at least in part on the probability associated with each of the plurality of candidate character strings, the at least one character included in the set of characters associated with the at least one control. To determine the current character of control 18A, string edit module 22 may first identify candidate character strings (e.g., all the character strings within lexicon data stores 60) that include the current characters of the other selected controls 18 (e.g., those controls 18 other than control 18A) in the corresponding character positions. For instance, consider that control 18B may be the only other previously selected one of controls 18 and the current character of control 18B may be the character ‘w’. String edit module 22 may identify as candidate character strings, one or more character strings within lexicon data stores 60 that include each of the current characters of each of the selected controls 18 in the character position that corresponds to the position of the selected controls 18, or in this case candidate character strings that have a ‘w’ in the second character position and any character in the first character position.

String edit module 22 may control (or limit) the selection of current characters of control 18A to be only those characters included in the corresponding character position (e.g., the first character position) of each of the candidate character strings that have a ‘w’ in the second character position. For instance, the first character of each candidate character string that has a second character ‘w’ may represent a potential new current character for control 18A. In other words, string edit module 22 may limit the selection of current characters for control 18A based on flinging gestures to those characters that may actually be used to enter one of the candidate character strings (e.g., one of the character strings in lexicon data stores 60 that have the character ‘w’ as a second letter).

Each of the respective characters associated with a selected character input control 18 may be associated with a respective probability that indicates whether the gesture represents a selection of the respective character. String edit module 22 may determine a subset of the plurality of characters (e.g., potential characters) of the character set corresponding to the selected one of controls 18. The respective probability associated with each character in the subset of potential characters may satisfy a threshold (e.g., the respective probabilities may be greater than a zero probability threshold). Each character in the subset may be associated with a relative ordering in the character set. The characters in the subset are ordered in an ordering in the subset. Each of the characters in the subset may have a relative position to the other characters in the subset. The relative position may be based on the relative ordering. For examples, the letter ‘a’ may be a first alpha character in the subset of characters and the letter ‘z’ may be a last alpha character in the subset of characters. In some examples, the ordering of the characters in the subset may be independent of either a numberical order or an alphabetic order.

String edit module 22 may determine, based on the relative ordereings of the characters in the subset, the at least one character. In some examples, the respective probability of one or more characters in the subset may exceed the respective probability associated with the at least one character. For instance, string edit module 22 may include characters in the subset that have greater probabilities than the respective probability associated with the at least one character.

For example, string edit module 22 may identify one or more potential current characters of control 18A that are included in the first character position of one or more candidate character strings having a second character ‘w’, and string edit module 22 may identify one or more non-potential current characters that are not found in the first character position of any of the candidate character strings having a second character ‘w’. For the potential current character ‘a’, string edit module 22 may identify candidate character strings “awesome”, “awful”, etc., for the potential current character ‘b’, string edit module may identify no candidate character strings (e.g., no candidate character strings may start with the prefix “bw”), and for each of the potential current characters ‘c’, ‘d’, etc., string edit module 22 may identify none, one, or more than one candidate character string that has the potential current character in the first character position and the character ‘w’ in the second.

String edit module 22 may next determine a probability (e.g., based on a relative frequency and/or a language model) of each of the candidate character strings. For example, lexicon data stores 60 may include an associated frequency probability each of the character strings that indicates how often the character string is used in communications (e.g., typed e-mails, text messages, etc.). The frequency probabilities may be predetermined based on communications received by other systems and/or based on communications received directly as user input by computing device 10. In other words, the frequency probability may represent a ratio between a quantity of occurrences of a character string in a communication as compared to a total quantity of all character strings used in the communication. String edit module 22 may determine the probability of each of the candidate character strings based on these associated frequency probabilities.

In addition string edit module 22 includes language model module 28 (LM module 28) and may determine a language model probability associated with each of the candidate character strings. LM module 28 may determine one or more character strings previously determined by computing device 10 prior to receiving the indication of gesture 4. LM module 28 may determine language model probabilities of each of the candidate character strings identified above based on previously entered character strings at edit region 14A. That is, LM module 28 may determine the language model probability that one or more of the candidate character strings stored in lexicon data stores 60 appears in a sequence of character strings subsequent to the character strings “check out this” (e.g., character strings previously entered in edit region 14A). In some examples, string edit module 22 may determine the probability of a candidate character string based on the language model probability or the frequency probability. In other examples, string edit module 22 may combine the frequency probability with the language model probability to determine the probability associated with each of the candidate character strings.

Having determined one or more candidate character strings, associated language model probabilities, and one or more potential current characters, string edit module 22 may determine a probability associated with each potential current character that indicates a likelihood of whether the potential current character is more or less likely to be the intended selected current character of control 18A. For example, for each potential current character, string edit module 22 may determine a probability of that potential character being a selected current character of control 18A. The probability of each potential character may be the normalized sum of the probabilities of each of the corresponding candidate character strings. For instance, for the character ‘a’, the probability that character ‘a’ is the current character of control 18A may be the normalized sum of the probabilities of the candidate character strings “awesome”, “awful”, etc. For the character ‘b’, the probability that character ‘b’ is the current character may be zero, since string edit module 22 may determine character ‘b’ has no associated candidate character strings.

In some examples, string edit module 22 may determine the potential character with the highest probability of all the potential characters corresponds to the “selected” and next current character of the selected one of controls 18. For example, consider the example probabilities of the potential current characters associated with selected control 18A listed below (e.g., where P( ) indicates a probability of a character within the parentheses and sum( ) indicates a sum of the items within the parentheses):
P(“a”)=20%, sum(P(“b”) . . . P(“h”))=2%, P(“i”)=16%, sum(P(T) . . . P(“l”))=5%, P(“m”)=18%, P(“n”)=14%, sum(P(“o”) . . . P(“q”))=6%, P(“r”)=15%, sum(P(“s”) . . . P(“z”))=4%
   In some examples, because character “a” has a higher probability (e.g., 20%) than each of the other potential characters, string edit module 22 may determine the new current character of control 18A is the character “a”.

In some examples however, string edit module 22 may determine the new current character is not the potential current character with the highest probability and rather may determine the potential current character that would require the least amount of effort by a user (e.g., in the form of speed of a gesture) to choose the correct character with an additional gesture. In other words, string edit module 22 may determine the new current character based on the relative positions of each of the potential characters within the character set associated with the selected control. For instance, using the probabilities of potential current characters, string edit module 22 may determine new current characters of selected controls 18 that minimize the average effort needed to enter candidate character strings. A new current character of a selected one of controls 18 may not be simply the most probable potential current character; rather string edit module 22 may utilize “average information gain” to determine the new current character. Even though character “a” may have higher probability than the other characters, character “a” may be at the start of the portion of the character set that corresponds to letters. If string edit module 22 is wrong in predicting character “a” as the new current character, the user may need to perform an additional fling with a greater amount of speed and distance to change the current character of control 18A to a different current character (e.g., since string edit module 22 may advance or regress the current character in the set by a quantity of characters based on the speed and distance of a gesture). String edit module 22 may determine that character “m”, although not the most probable current character based on gesture 4 used to select control 18A, is near the middle of the alpha character portion of the set of characters associated with control 18A and may provide a better starting position for subsequent gestures (e.g., flings) to cause the current character to “land on” the character intended to be selected by the user. In other words, string edit module 22 forgo the opportunity to determine the correct current character of control 18A based on gesture 4 (e.g., a first gesture) to instead increase the likelihood that subsequent flings to select the current character of control 18A may require less speed and distance (e.g., effort).

In some examples, string edit module 22 may determine only some of the potential current characters (regardless of these probabilities) can be reached based on characteristics of the received gesture. For instance, string edit module 22 may determine the speed and/or distance of gesture 4 does not satisfy a threshold to cause string edit module 22 to advance or regress (e.g., move up or down) the current character of a selected control 18 within an associated character set to character “m” and determine character “a”, in addition to being more probable, is the current character of control 18A. In this way, string edit module 22 may utilize “intelligent flinging” or “predictive flinging” based on character prediction and/or language modeling techniques to determine how far to advance or regress (e.g., move up or down) the current character of a selected control 18 within an associated character set based on the characteristics of gesture 4 and the determined probabilities of the potential current characters.

Computing device 10 may receive indications of gestures 5, 6, and 7 (in no particular order) at UID 12 to select controls 18B, 18G, and 18H respectively. String edit module 22 may receive a sequence of touch events and characteristics of each of gestures 5-7 from UI module 20. String edit module 22 may determine a current character in the set of characters associated with each one of selected controls 18B, 18G, and 18H based on characteristics of each of these gestures and the predictive flinging techniques described above. String edit module 22 may determine the current character of control 18B, 18G, and 18H, respectively, is the letter w, the letter e, and the space character.

As string edit module 22 determines the new current character of each selected one of controls 18, string edit module 22 may output information to UI module 20 for presenting the new current characters at UID 12. String edit module 22 may further include in the outputted information to UI module 20, a command to update the presentation of user interface 8 to include a visual indication of the selections of controls 18 (e.g., coloration, bold lettering, outlines, etc.).

Computing device 10 may determine, based at least in part on the at least one character, a candidate character string. In other words, string edit module 22 may determine from the character strings stored at lexicon data stores 60, a candidate (e.g., potential) character string for inclusion in edit region 14A based on the current characters of selected controls 18. For example, string edit module 22 may concatenate each of the current characters of each of the controls 18A through 18N to determine a current character string. The first character of the current character string may be the current character of control 18A, the last character of the current character string may be the current character of control 18N, and the middle characters of the current character string may be the current characters of each of controls 18B through 18N-1. Based on gestures 4 through 7, string edit module 22 may determine the current character string is, for example, a string of characters including ‘a’+‘w’+‘ ’+‘ ’+‘ ’+‘ ’+‘e’+‘ ’+ . . . +‘ ’.

String edit module 22 may determine, based at least in part on the at least one character, an end-of-string identifier corresponding to the at least one character, determine, based at least in part on the end-of-string identifier, a predicted length of the candidate character string, and determine, based at least in part on the predicted length, the candidate character string. In other words, each of controls 18 corresponds to a character position of candidate character strings. Control 18A may correspond to the first character position (e.g., the left most or lowest character position), and control 18N may correspond to the last character position (e.g., the right most or highest character position). String edit module 22 may determine that the left most positioned one of controls 18 that has an end-of-string identifier (e.g., a punctuation character, a control character, a whitespace character, etc.) as a current character, represents the capstone, or end of the character string being entered through selections of control 18. String edit module 22 may limit the determination of candidate character strings to character strings that have a length (e.g., a quantity of characters), that corresponds to the quantity of character input controls 18 that appear prior to left of the left most character input control 18 that has an end-of-string identifier as a current character. For example, string edit module 22 may limit the determination of candidate character strings to character strings that have exactly seven characters (e.g., the quantity of character input controls 18 positioned to the left of control 18H) because selected control 18H includes a current character represented by an end-of-string identifier (e.g., a space character).

In some examples, computing device 10 may transpose the at least one character input control with a different character input control of the plurality of character input controls based at least in part on the characteristic of the gesture, and modify the predicted length (e.g., to increase the length or decrease the length) of the candidate character string based at least in part on the transposition. In other words, a user may gesture at UID 12 by swiping a finger and/or stylus pen left and or right across edit region 14A. String edit module 22 may determine that in some cases, a swipe gesture to the left or right across edit region 14A corresponds to dragging one of controls 18 from right-to-left or left-to-right across UID 12 may cause string edit module 22 to transpose (e.g., move) that control 18 to a different position amongst the other controls 18. In addition, by transposing one of controls 18, string edit module 22 may also transpose the character position of the candidate character string that corresponds to the dragged control 18. For instance, dragging control 18N from the right side of UID 12 to the left side may transpose the nth character of the candidate character string to the nth-1 position, the nth-2 position, etc., and those characters that previously were in the nth-1, nth-2, etc., positions of the candidate character string to shift to the right and fill the nth, nth-1, etc. characters of the candidate character string. In some examples, string edit module 22 may transpose the current characters of the character input controls without transposing the character input controls themselves. In some examples, string edit module 22 may transpose the actual character input controls to transpose the current characters.

String edit module 22 may modify the length of the candidate character string (e.g., to increase the length or decrease the length) if the current character of a dragged control 18 is an end-of string identifier. For instance, if the current character of control 18N is a space character, and control 18N is dragged right, string edit module 22 may increase the length of candidate character strings and if control 18N is dragged left, string edit module 22 may decrease the length.

String edit module 22 may further control or limit the determination of a candidate character string to a character string that has each of the current characters of selected controls 18 in a corresponding character position. That is, string edit module 22 may control or limit the determination of the candidate character string to be, not only a character string that is seven characters long, but also a character string having ‘a’ and ‘w’ in the first two character positions and the character ‘e’ in the last or seventh character position.

String edit module 22 may utilize similarity coefficients to determine the candidate character string. In other words, string edit module 22 may scan one or more lexicons within lexicon data stores 60 for a character string that has a highest similarity coefficient and is more inclusive of the current characters included in the selected controls 18 than the other character strings in lexicon data stores 60. String edit module 22 may perform a lookup within lexicon data stores 60 based on the current characters included in the selected controls 18, to identify one or more candidate character strings that include some or all of the current selected characters. String edit module 22 may assign a similarity coefficient to each candidate character string that indicates a degree of likelihood that the current selected characters actually represents a selection of controls 18 to input the candidate character string in edit region 14A. In other words, the one or more candidate character strings may represent character strings that include the spelling or arrangements of the current characters in the selected controls 18.

String edit module 22 may utilize LM module 28 to determine a candidate character string. In other words, string edit module 22 may invoke LM module 28 to determine a language model probability of each of the candidate character strings determined from lexicon data stores 60 to determine one candidate character string that more likely represents the character string being entered by the user. LM module 28 may determine a language model probability for each of the candidate character string that indicates a degree of likelihood that each of the respective candidate character strings follows the sequence of character strings previously entered into edit region 14A (e.g., “check out this”). LM module 28 may compare the language model probability of each of the candidate character strings to a minimum language model probability threshold and in the event none of the candidate character strings have a language model probability that satisfies the threshold, LM module 28 may utilize back-off techniques to determine a candidate character string that does have a LMP that satisfies the threshold. LM module 28 of string edit module 22 may determine that the candidate character string with each of the current characters of the selected controls 18 and the highest language model probability of all the candidate character strings is the character string “awesome”.

In response to determining the candidate character string, computing device 10 may output, for display, the candidate character string. In some examples, computing device 10 may determine, based at least in part on the candidate character string, a character included in the set of characters associated with a character input control that is different than the at least one character input control of the plurality of character input controls. For example, in response to determining the candidate character string is “awesome,” string edit module 22 may present the candidate character string across controls 18 by setting the current characters of the unselected controls 18 (e.g., controls 18C, 18D, 18E, and 18F) to characters in corresponding character positions of the candidate character string. Or in other words, controls 18C, 18D, 18E, and 18F which are unselected (e.g., unselected) may be assigned a new current character that is based on one of the characters of the candidate character string. Controls 18C, 18D, 18E, and 18F correspond, respectively, to the third, fourth, fifth, and sixth character positions of the candidate character string. String edit module 22 may send information to UI module 20 for altering the presentation of controls 18C through 18F to include and present the current characters ‘e’, ‘s’, ‘o’, and ‘m’ within controls 18C through 18F. UI module 20 may receive the information and cause UID 12 to present the letters ‘e’, ‘s’, ‘o’, and ‘m’ within controls 18C through 18F.

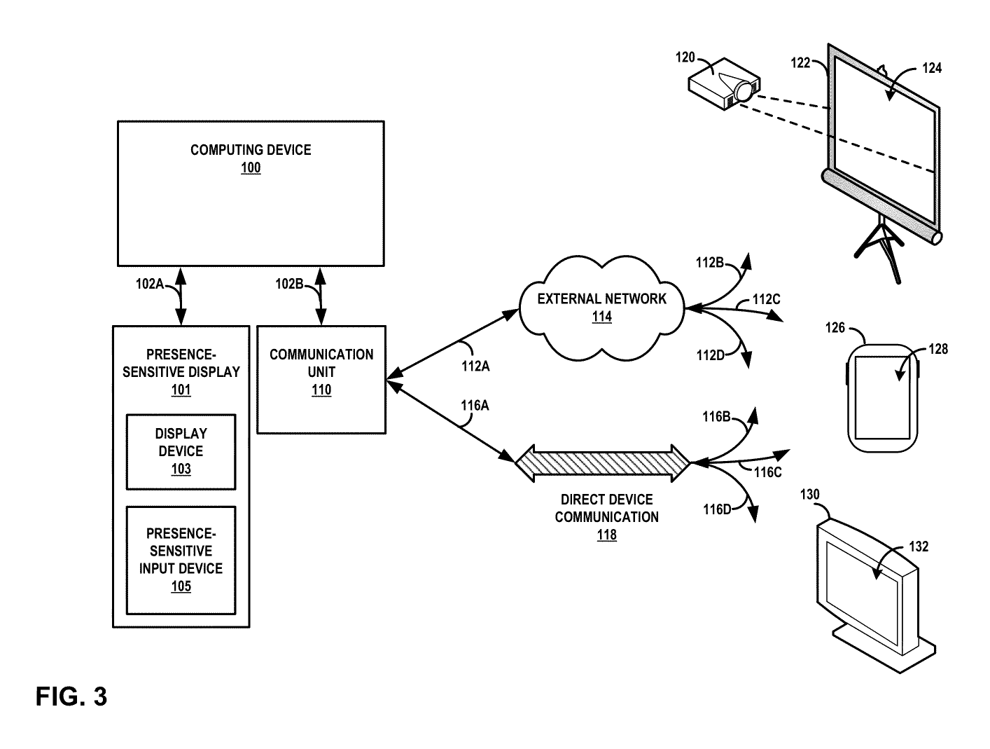

FIG. 3 is a block diagram illustrating an example computing device that outputs graphical content for display at a remote device, in accordance with one or more techniques of the present disclosure. Graphical content, generally, may include any visual information that may be output for display, such as text, images, a group of moving images, etc. The example shown in FIG. 3 includes a computing device 100, presence-sensitive display 101, communication unit 110, projector 120, projector screen 122, mobile device 126, and visual display device 130. Although shown for purposes of example in FIGS. 1 and 2 as a stand-alone computing device 10, a computing device such as computing devices 10, 100 may, generally, be any component or system that includes a processor or other suitable computing environment for executing software instructions and, for example, need not include a presence-sensitive display.

As shown in the example of FIG. 3, computing device 100 may be a processor that includes functionality as described with respect to processor 40 in FIG. 2. In such examples, computing device 100 may be operatively coupled to presence-sensitive display 101 by a communication channel 102A, which may be a system bus or other suitable connection. Computing device 100 may also be operatively coupled to communication unit 110, further described below, by a communication channel 102B, which may also be a system bus or other suitable connection. Although shown separately as an example in FIG. 3, computing device 100 may be operatively coupled to presence-sensitive display 101 and communication unit 110 by any number of one or more communication channels.

In other examples, such as illustrated previously by computing device 10 in FIGS. 1-2, a computing device may refer to a portable or mobile device such as mobile phones (including smart phones), laptop computers, etc. In some examples, a computing device may be a desktop computers, tablet computers, smart television platforms, cameras, personal digital assistants (PDAs), servers, mainframes, etc.

Presence-sensitive display 101 may include display device 103 and presence-sensitive input device 105. Display device 103 may, for example, receive data from computing device 100 and display the graphical content. In some examples, presence-sensitive input device 105 may determine one or more inputs (e.g., continuous gestures, multi-touch gestures, single-touch gestures, etc.) at presence-sensitive display 101 using capacitive, inductive, and/or optical recognition techniques and send indications of such input to computing device 100 using communication channel 102A. In some examples, presence-sensitive input device 105 may be physically positioned on top of display device 103 such that, when a user positions an input unit over a graphical element displayed by display device 103, the location at which presence-sensitive input device 105 corresponds to the location of display device 103 at which the graphical element is displayed. In other examples, presence-sensitive input device 105 may be positioned physically apart from display device 103, and locations of presence-sensitive input device 105 may correspond to locations of display device 103, such that input can be made at presence-sensitive input device 105 for interacting with graphical elements displayed at corresponding locations of display device 103.

As shown in FIG. 3, computing device 100 may also include and/or be operatively coupled with communication unit 110. Communication unit 110 may include functionality of communication unit 44 as described in FIG. 2. Examples of communication unit 110 may include a network interface card, an Ethernet card, an optical transceiver, a radio frequency transceiver, or any other type of device that can send and receive information. Other examples of such communication units may include Bluetooth, 3G, and Wi-Fi radios, Universal Serial Bus (USB) interfaces, etc. Computing device 100 may also include and/or be operatively coupled with one or more other devices, e.g., input devices, output devices, memory, storage devices, etc. that are not shown in FIG. 3 for purposes of brevity and illustration.

FIG. 3 also illustrates a projector 120 and projector screen 122. Other such examples of projection devices may include electronic whiteboards, holographic display devices, and any other suitable devices for displaying graphical content. Projector 120 and projector screen 122 may include one or more communication units that enable the respective devices to communicate with computing device 100. In some examples, the one or more communication units may enable communication between projector 120 and projector screen 122. Projector 120 may receive data from computing device 100 that includes graphical content. Projector 120, in response to receiving the data, may project the graphical content onto projector screen 122. In some examples, projector 120 may determine one or more inputs (e.g., continuous gestures, multi-touch gestures, single-touch gestures, etc.) at projector screen 122 using optical recognition or other suitable techniques and send indications of such input using one or more communication units to computing device 100. In such examples, projector screen 122 may be unnecessary, and projector 120 may project graphical content on any suitable medium and detect one or more user inputs using optical recognition or other such suitable techniques.

Projector screen 122, in some examples, may include a presence-sensitive display 124. Presence-sensitive display 124 may include a subset of functionality or all of the functionality of UI device 4 as described in this disclosure. In some examples, presence-sensitive display 124 may include additional functionality. Projector screen 122 (e.g., an electronic whiteboard), may receive data from computing device 100 and display the graphical content. In some examples, presence-sensitive display 124 may determine one or more inputs (e.g., continuous gestures, multi-touch gestures, single-touch gestures, etc.) at projector screen 122 using capacitive, inductive, and/or optical recognition techniques and send indications of such input using one or more communication units to computing device 100.

FIG. 3 also illustrates mobile device 126 and visual display device 130. Mobile device 126 and visual display device 130 may each include computing and connectivity capabilities. Examples of mobile device 126 may include e-reader devices, convertible notebook devices, hybrid slate devices, etc. Examples of visual display device 130 may include other semi-stationary devices such as televisions, computer monitors, etc. As shown in FIG. 3, mobile device 126 may include a presence-sensitive display 128. Visual display device 130 may include a presence-sensitive display 132. Presence-sensitive displays 128, 132 may include a subset of functionality or all of the functionality of UID 12 as described in this disclosure. In some examples, presence-sensitive displays 128, 132 may include additional functionality. In any case, presence-sensitive display 132, for example, may receive data from computing device 100 and display the graphical content. In some examples, presence-sensitive display 132 may determine one or more inputs (e.g., continuous gestures, multi-touch gestures, single-touch gestures, etc.) at projector screen using capacitive, inductive, and/or optical recognition techniques and send indications of such input using one or more communication units to computing device 100.

As described above, in some examples, computing device 100 may output graphical content for display at presence-sensitive display 101 that is coupled to computing device 100 by a system bus or other suitable communication channel. Computing device 100 may also output graphical content for display at one or more remote devices, such as projector 120, projector screen 122, mobile device 126, and visual display device 130. For instance, computing device 100 may execute one or more instructions to generate and/or modify graphical content in accordance with techniques of the present disclosure. Computing device 100 may output the data that includes the graphical content to a communication unit of computing device 100, such as communication unit 110. Communication unit 110 may send the data to one or more of the remote devices, such as projector 120, projector screen 122, mobile device 126, and/or visual display device 130. In this way, computing device 100 may output the graphical content for display at one or more of the remote devices. In some examples, one or more of the remote devices may output the graphical content at a presence-sensitive display that is included in and/or operatively coupled to the respective remote devices.

In some examples, computing device 100 may not output graphical content at presence-sensitive display 101 that is operatively coupled to computing device 100. In other examples, computing device 100 may output graphical content for display at both a presence-sensitive display 101 that is coupled to computing device 100 by communication channel 102A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 100 and output for display at presence-sensitive display 101 may be different than graphical content display output for display at one or more remote devices.

Computing device 100 may send and receive data using any suitable communication techniques. For example, computing device 100 may be operatively coupled to external network 114 using network link 112A. Each of the remote devices illustrated in FIG. 3 may be operatively coupled to network external network 114 by one of respective network links 112B, 112C, and 112D. External network 114 may include network hubs, network switches, network routers, etc., that are operatively inter-coupled thereby providing for the exchange of information between computing device 100 and the remote devices illustrated in FIG. 3. In some examples, network links 112A-112D may be Ethernet, ATM or other network connections. Such connections may be wireless and/or wired connections.

In some examples, computing device 100 may be operatively coupled to one or more of the remote devices included in FIG. 3 using direct device communication 118. Direct device communication 118 may include communications through which computing device 100 sends and receives data directly with a remote device, using wired or wireless communication. That is, in some examples of direct device communication 118, data sent by computing device 100 may not be forwarded by one or more additional devices before being received at the remote device, and vice-versa. Examples of direct device communication 118 may include Bluetooth, Near-Field Communication, Universal Serial Bus, Wi-Fi, infrared, etc. One or more of the remote devices illustrated in FIG. 3 may be operatively coupled with computing device 100 by communication links 116A-116D. In some examples, communication links 112A-112D may be connections using Bluetooth, Near-Field Communication, Universal Serial Bus, infrared, etc. Such connections may be wireless and/or wired connections.

In accordance with techniques of the disclosure, computing device 100 may be operatively coupled to visual display device 130 using external network 114. Computing device 100 may output, for display, a plurality of controls 18, wherein a plurality of characters of a character set is associated with at least one control of the plurality of controls 18. For example. Computing device 100 may transmit information using external network 114 to visual display device 130 that causes visual display device 130 to present user interface 8 having controls 18. Computing device 100 may receive an indication of a gesture to select the at least one control 18. For instance, communication unit 110 of computing device 100 may receive information over external network 114 from visual display device 130 that indicates gesture 4 was detected at presence-sensitive display 132.

Computing device 100 may determine, based at least in part on a characteristic of the gesture, at least one character included in the set of characters associated with the at least one control 18. For example, string edit module 22 may receive the information about gesture 4 and determine gesture 4 represents a selection of one of controls 18. Based on characteristics of gesture 4 and intelligent fling techniques described above, string edit module 22 may determine the character being selected by gesture 4. Computing device 100 may determine, based at least in part on the at least one character, a candidate character string. For instance, using LM module 28, string edit module 22 may determine that the “awesome” represents a likely candidate character string that follows the previously entered character strings “check out this” in edit region 14A and includes the selected character. In response to determining the candidate character string, computing device 100 may output, for display, the candidate character string. For example, computing device 100 may send information over external network 114 to visual display device 30 that causes visual display device 30 to present the individual characters of candidate character string “awesome” as the current characters of controls 18.

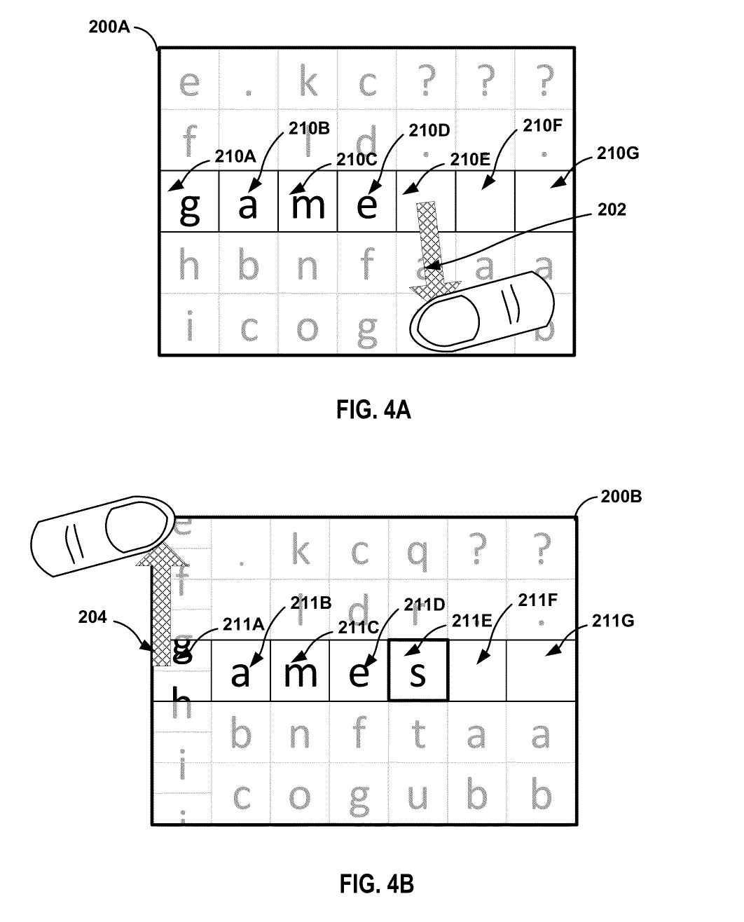

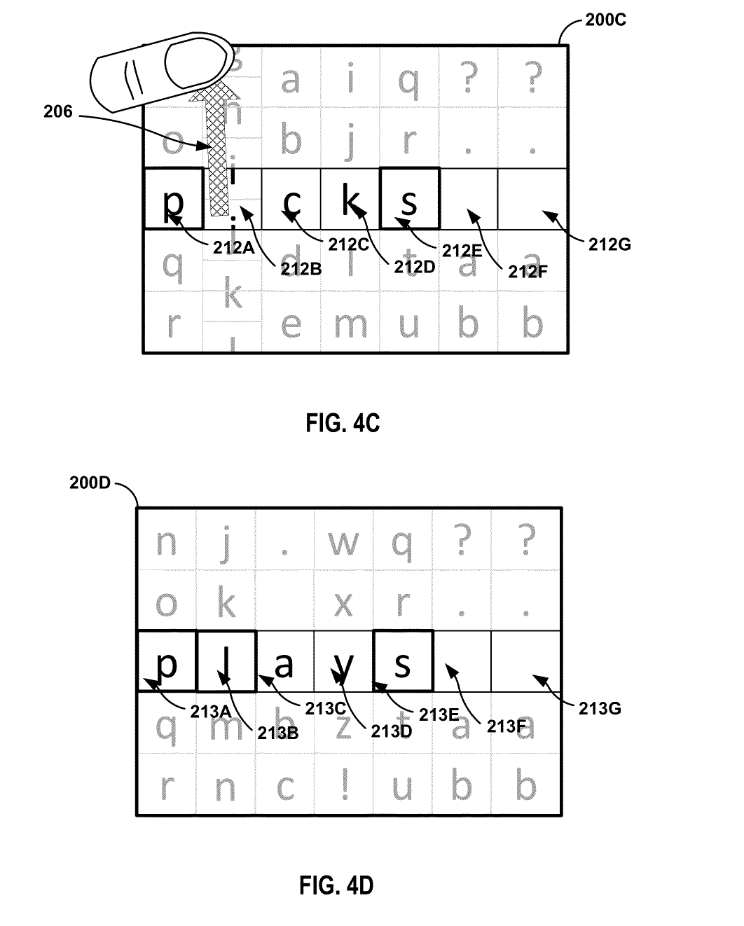

FIGS. 4A-4D are conceptual diagrams illustrating example graphical user interfaces for determining order-independent text input, in accordance with one or more aspects of the present disclosure. FIGS. 4A-4D are described below in the context of computing device 10 (described above) from FIG. 1 and FIG. 2. The example illustrated by FIGS. 4A-4D shows that, in addition to determining a character string based on ordered input to select character input controls, computing device 10 may determine a character string based on out-of-order input of character input controls. For example, FIG. 4A shows user interface 200A which includes character input controls 210A, 210B, 210C, 210D, 210E, 210F, and 210G (collectively controls 210).

Computing device 10 may determine a candidate character string being entered by a user based on selections of controls 210. These sections may further cause computing device 10 to output the candidate character string for display. For example, computing device 10 may cause UID 12 to update the respective current characters of controls 210 with the characters of the candidate character string. For example, prior to receiving any of the gestures shown in FIGS. 4A-4D, computing device 10 may determine a candidate character string that a user may enter using controls 210 is the string “game.” For instance, using a language model, string edit module 22 may determine a more likely character strings to follow previously entered character strings at computing device 10 is the character string “game.” Computing device 10 may present the individual characters of character string “game” as the current characters of controls 210. Computing device 10 may include end-of-string characters as the current characters of controls 210E-21 OG since the character string game includes a fewer quantity of characters than the quantity of controls 210.

Computing device 10 may receive an indication of gesture 202 to select character input control 210E. Computing device 10 may determine, based at least in part on a characteristic of gesture 202, at least one character included in the set of characters associated character input control 210E. For instance, string edit module 22 of computing device 10 may determine (e.g., based on the speed of gesture 202, the distance of gesture 202, predictive fling techniques, etc.) that character ‘s’ is the selected character. Computing device 10 may determine, based at least in part on the selected character ‘s’, a new candidate character string. For instance, computing device 10 may determine the character string “games” is a likely character string to follow previously entered character strings at computing device 10. In response to determining the candidate character string “games,” computing device 10 may output for display, the individual characters of the candidate character string “games” as the current characters of controls 210.

FIG. 4B shows user interface 200B which represents an update to controls 210 and user interface 200A in response to gesture 202. User interface 200B includes controls 211A-211G (collectively controls 211) which correspond to controls 210 of user interface 200A of FIG. 4A. Computing device 10 may present a visual cue or indication of the selection of control 210E (e.g., FIG. 4B shows a bolded rectangle surrounding control 211E). Computing device 10 may receive an indication of gesture 204 to select character input control 211A. Computing device 10 may determine, based at least in part on a characteristic of gesture 204, at least one character included in the set of characters associated character input control 211A. For instance, string edit module 22 of computing device 10 may determine (e.g., based on the speed of gesture 204, the distance of gesture 204, predictive fling techniques, etc.) that character ‘p’ is the selected character. Computing device 10 may determine, based at least in part on the selected character ‘p’, a new candidate character string. For instance, computing device 10 may determine the character string “picks” is a likely character string to follow previously entered character strings at computing device 10 that has the selected character ‘p’ as a first character and the selected character ‘s’ as a last character. In response to determining the candidate character string “picks,” computing device 10 may output for display, the individual characters of the candidate character string “picks” as the current characters of controls 210.

FIG. 4C shows user interface 200C which represents and update to controls 210 and user interface 200B in response to gesture 204. User interface 200C includes controls 212A-212G (collectively controls 212) which correspond to controls 211 of user interface 200B of FIG. 4B. Computing device 10 may receive an indication of gesture 206 to select character input control 212B. String edit module 22 of computing device 10 may determine that character ‘l’ is the selected character. Computing device 10 may determine, based at least in part on the selected character ‘l’, a new candidate character string. For instance, computing device 10 may determine the character string “plays” is a likely character string to follow previously entered character strings at computing device 10 that has the selected character ‘p’ as a first character, the selected character ‘1’ as the second character, and the selected character ‘s’ as a last character. In response to determining the candidate character string “plays,” computing device 10 may output for display, the individual characters of the candidate character string “plays” as the current characters of controls 210. FIG. 4D shows user interface 200D which includes controls 213A-213G (collectively controls 213) which represents an update to controls 212 and user interface 200C in response to gesture 206. A user may swipe at UID 12 or provide some other input at computing device 10 to confirm the character string being displayed across controls 210.

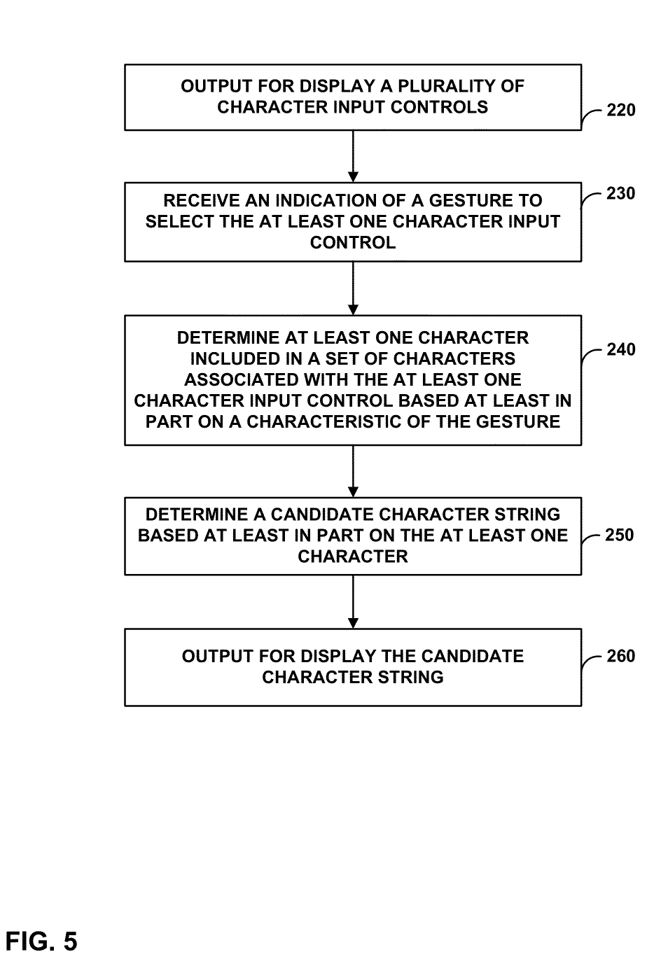

FIG. 5 is a flowchart illustrating an example operation of the computing device, in accordance with one or more aspects of the present disclosure. The process of FIG. 5 may be performed by one or more processors of a computing device, such as computing device 10 illustrated in FIG. 1 and FIG. 2. For purposes of illustration only, FIG. 5 is described below within the context of computing devices 10 of FIG. 1 and FIG. 2.

In the example of FIG. 5, a computing device may output, for display, a plurality of character input controls (220). For example, UI module 20 of computing device 10 may receive from string edit module 22 a graphical layout of controls 18. The layout may include information including which character of an ASCII character set to present as the current character within a respective one of controls 18. UI module 20 may update user interface 8 to include controls 18 and the respective current characters according to the graphical layout from string edit module 22. UI module 20 may cause UID 12 to present user interface 8.

Computing device 10 may receive an indication of a gesture to select the at least one control (230). For example, a user of computing device 10 may wish to enter a character string within edit region 14A of user interface 8. The user may provide gesture 4 at a portion of UID 12 that corresponds to a location where UID 12 presents one or more of controls 18. Gesture module 24 may receive information about gesture 4 from UID as UID 12 detects gesture 4 being entered. Gesture module 24 may assemble the information from UID 12 into a sequence of touch events corresponding to gesture 4 and may determine one or more characteristics of gesture 4. Gesture module 24 may transmit the sequence of touch events and characteristics of gesture 4 to UI module 20 which may pass data corresponding to the touch events and characteristics of gesture 4 to string edit module 22.

Computing device 10 may determine at least one character included in a set of characters associated with the at least one control based at least in part on a characteristic of the gesture (240). For example, based on the data from UI module 20 about gesture 4, string edit module 22 may determine a selection of control 18A. String edit module 22 may determine, based at least in part on the one or more characteristics of gesture 4, a current character included in the set of characters of selected control 18A. In addition to the characteristics of gesture 4, string edit module 22 may determine the current character of control 18A based on character string prediction techniques and/or intelligent flinging techniques. Computing device 10 may determine the current character of control 18A is the character ‘a’.

Computing device 10 may determine a candidate character string based at least in part on the at least one character (250). For instance, string edit module 22 may utilize similarity coefficients and/or language model techniques to determine a candidate character string that includes the current character of selected control 18A in the character position that corresponds to control 18A. In other words, string edit module 22 may determine a candidate character string that begins with the character ‘a’ (e.g., the string “awesome”).

In response to determining the candidate character string, computing device 10 may output, for display, the candidate character string (260). For example, string edit module 22 may send information to UI module 20 for updating the presentation of the current characters of controls 18 to include the character ‘a’ in control 18A and include the other characters of the string “awesome” as the current characters of the other, unselected controls 18. UI module 20 may cause UID 12 to present the individual characters of the string “awesome” as the current characters of controls 18.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
outputting, by a computing device and for display, a plurality of character input controls, wherein a plurality of characters of a character set is associated with at least one character input control of the plurality of character input controls;
receiving, by the computing device, an indication of a gesture to select the at least one character input control;
determining, by the computing device and based at least in part on a characteristic of the gesture, at least one character included in the set of characters associated with the at least one character input control;
determining, by the computing device and based at least in part on the at least one character, a candidate character string; and
in response to determining the candidate character string, outputting, by the computing device and for display, the candidate character string.

2. The method of claim 1, wherein the candidate character string is included as one of a plurality of candidate character strings, the method further comprising:
determining, by the computing device, one or more selected characters that each respectively correspond to a different character input control of the plurality of character input controls;
determining, by the computing device and based on the one or more selected characters, the plurality of candidate character strings, wherein each of the plurality of candidate character strings comprises the one or more selected characters, and wherein each of the plurality of candidate character strings is associated with a respective probability that the gesture indicates a selection of the candidate character string; and
determining, by the computing device and based at least in part on the probability associated with each of the plurality of candidate character strings, the at least one character included in the set of characters associated with the at least one character input control.

3. The method of claim 1,
wherein each respective character of the plurality of characters associated with the selected at least one character input control is associated with a respective probability that indicates whether the gesture represents a selection of the respective character, the method further comprising:
determining, by the computing device, a subset of the plurality of characters, wherein the respective probability associated with each character in the subset satisfies a threshold, and wherein each character in the subset is associated with a relative ordering in the character set, wherein the characters in the subset are ordered in an ordering in the subset; and
determining, by the computing device and based on relative orderings of the characters in the subset, the at least one character.

4. The method of claim 3,
wherein the respective probability of one or more characters in the subset exceeds the respective probability associated with the at least one character.

5. The method of claim 1, further comprising:
determining, by the computing device, one or more character strings previously determined by the computing device prior to receiving the indication of the gesture; and
determining, by the computing device, and based on the one or more character strings and the at least one character, a language model probability of the candidate character string, wherein the language model probability indicates a likelihood that the candidate character string is positioned subsequent to the one or more character strings in a sequence of character strings comprising the one or more character strings and the candidate character string,
wherein determining the candidate character string is based at least in part on the language model probability.

6. The method of claim 1, further comprising:
receiving, by the computing device, an indication of an input to confirm the candidate character string, wherein the candidate character string is outputted for display in response to the input.

7. The method of claim 1, further comprising:
determining, by the computing device and based at least in part on the at least one character, an end-of-string identifier corresponding to the at least one character, wherein the end-of-string identifier indicates a last character of a character string;
determining, by the computing device and based at least in part on the end-of-string identifier, a predicted length of the candidate character string; and
determining, by the computing device and based at least in part on the predicted length, the candidate character string.

8. The method of claim 8, further comprising:
transposing, by the computing device and based at least in part on the characteristic of the gesture, the at least one character input control with a different character input control of the plurality of character input controls; and
modifying, by the computing device and based at least in part on the transposition, the predicted length of the candidate character string.

9. The method of claim 1, wherein the at least one character input control is a first character input control, the method further comprising:
determining, by the computing device and based at least in part on the candidate character string, a character included in the set of characters associated with a second character input control that is different than the first character input control of the plurality of character input controls.

10. A computer-readable storage medium encoded with instructions that, when executed, cause at least one processor of a computing device to:
output, for display, a plurality of character input controls, wherein a plurality of characters of a character set is associated with at least one character input control of the plurality of character input controls;
receive, an indication of a gesture to select the at least one character input control;
determine, based at least in part on a characteristic of the gesture, at least one character included in the set of characters associated with the at least one character input control;
determine, based at least in part on the at least one character, a candidate character string; and
in response to determining the candidate character string, output, for display, the candidate character string.

11. The computer-readable storage medium of claim 10, wherein the candidate character string is included as one of a plurality of candidate character strings, the computer-readable storage medium being further encoded with instructions that, when executed, cause the at least one processor of the computing device to:
determine, one or more selected characters that each respectively correspond to a different character input control of the plurality of character input controls;
determine, based on the one or more selected characters, the plurality of candidate character strings, wherein each of the plurality of candidate character strings comprises the one or more selected characters, and wherein each of the plurality of candidate character strings is associated with a respective probability that the gesture indicates a selection of the candidate character string; and
determine, based at least in part on the probability associated with each of the plurality of candidate character strings, the at least one character included in the set of characters associated with the at least one character input control.

12. The computer-readable storage medium of claim 10,
wherein each respective character of the plurality of characters associated with the selected at least one character input control is associated with a respective probability that indicates whether the gesture represents a selection of the respective character, the computer-readable storage medium being further encoded with instructions that, when executed, cause the at least one processor of the computing device to:
determine, a subset of the plurality of characters, wherein the respective probability associated with each character in the subset satisfies a threshold, and wherein each character in the subset is associated with a relative ordering in the character set, wherein the characters in the subset are ordered in an ordering in the subset; and
determine, based on relative orderings of the characters in the subset, the at least one character.

13. The computer-readable storage medium of claim 12,
wherein the respective probability of one or more characters in the subset exceeds the respective probability associated with the at least one character.

14. The computer-readable storage medium of claim 10, being further encoded with instructions that, when executed, cause the at least one processor of the computing device to:
determine, one or more character strings previously determined by the computing device prior to receiving the indication of the gesture; and
determine, based on the one or more character strings and the at least one character, a language model probability of the candidate character string, wherein the language model probability indicates a likelihood that the candidate character string is positioned subsequent to the one or more character strings in a sequence of character strings comprising the one or more character strings and the candidate character string,
wherein the candidate character string is determined based at least in part on the language model probability.

15. The computer-readable storage medium of claim 10, being further encoded with instructions that, when executed, cause the at least one processor of the computing device to:
determine, based at least in part on the at least one character, an end-of-string identifier corresponding to the at least one character, wherein the end-of-string identifier indicates a last character of a character string;
determine, based at least in part on the end-of-string identifier, a predicted length of the candidate character string; and
determine, based at least in part on the predicted length, the candidate character string.

16. A computing device comprising:
at least one processor;
a presence-sensitive input device;
a display device; and
at least one module operable by the at least one processor to:
output, for display at the display device, a plurality of character input controls, wherein a plurality of characters of a character set is associated with at least one character input control of the plurality of character input controls;
receive, an indication of a gesture detected at the presence-sensitive input device to select the at least one character input control;
determine, based at least in part on a characteristic of the gesture, at least one character included in the set of characters associated with the at least one character input control;
determine, based at least in part on the at least one character, a candidate character string; and
in response to determining the candidate character string, output, for display at the display device, the candidate character string.

17. The computing device of claim 16, wherein the candidate character string is included as one of a plurality of candidate character strings, the at least one module being further operable by the at least one processor to:
determine, one or more selected characters that each respectively correspond to a different character input control of the plurality of character input controls;
determine, based on the one or more selected characters, the plurality of candidate character strings, wherein each of the plurality of candidate character strings comprises the one or more selected characters, and wherein each of the plurality of candidate character strings is associated with a respective probability that the gesture indicates a selection of the candidate character string; and
determine, based at least in part on the probability associated with each of the plurality of candidate character strings, the at least one character included in the set of characters associated with the at least one character input control.

18. The computing device of claim 16,
wherein each respective character of the plurality of characters associated with the selected at least one character input control is associated with a respective probability that indicates whether the gesture represents a selection of the respective character, the at least one module being further operable by the at least one processor to:
determine, a subset of the plurality of characters, wherein the respective probability associated with each character in the subset satisfies a threshold, and wherein each character in the subset is associated with a relative ordering in the character set, wherein the characters in the subset are ordered in an ordering in the subset; and
determine, based on relative orderings of the characters in the subset, the at least one character.

19. The computing device of claim 16, the at least one module being further operable by the at least one processor to:
determine, based at least in part on the at least one character, an end-of-string identifier corresponding to the at least one character, wherein the end-of-string identifier indicates a last character of a character string;
determine, based at least in part on the end-of-string identifier, a predicted length of the candidate character string; and
determine, based at least in part on the predicted length, the candidate character string.

20. The computing device of claim 16, the at least one module being further operable by the at least one processor to:
detect the gesture at a portion of the presence-sensitive input device that corresponds to a location of the display device where the at least one character input control is displayed.
